(19) United States
(12) Patent Application Publication
(10) Pub. No.: US 2024/0389550 A1
(43) Pub. Date: Nov. 28, 2024

(54) Timed Feed Door Device for Gravity-Fed Deer Feeders

(71) Applicants: Andy McMillan, Hickory, MS (US); Shane Vogt, Steamboat Springs, CO (US)

(72) Inventors: Andy McMillan, Hickory, MS (US); Shane Vogt, Steamboat Springs, CO (US)

(21) Appl. No.: 18/665,463

(22) Filed: May 15, 2024

Related U.S. Application Data
(60) Provisional application No. 63/468,372, filed on May 23, 2023.

(51) Int. Cl. A01K 5/02

(52) U.S. Cl. CPC A01K 5/0291; A01K 5/0225

(57) ABSTRACT

A timed feed door device that is adapted to be removably engaged to and be in volumetric communication with an interior volume of a gravity-fed vessel that contains a dry granular product, the vessel is disposed in an exterior environment, the vessel having an outlet port protrusion. The timed feed door device including a first surrounding sidewall that is in communication with the outlet port, a second surrounding sidewall, and a third surrounding sidewall that are all in fluid communication with one another, further included is a door that has a pivotal attachment to the third surrounding sidewall, wherein the door has a timed closed and open state that facilitates flow of the dry granular product from the vessel to the third surrounding sidewall and then to the exterior environment.

### CROSS-REFERENCE TO RELATED APPLICATION

This application claims the benefit of U.S. provisional patent application Ser. No. 63/468,372 filed on May 23, 2023 by Andy McMillan of Hickory, MS, U.S.

### BACKGROUND OF THE INVENTION

Many hunters use deer feeders to attract deer. However, much of the feed is consumed at night by deer and by other animals. This is undesirable, as the deer feed is then wasted.

Therefore, there exists a long-felt need in the art for an improved deer feeder. There also exists a long-felt need in the art for a timed feed door device for gravity-fed deer feeders that prevents deer feed from a deer feeder from being eaten during the night. In addition, there exists a long-felt need in the art for a timed feed door device for gravity-fed deer feeders that can be universally applied to any gravity-fed style deer feeder.

The present invention is preferably comprised of a timed feed door device for gravity-fed deer feeders. The device is comprised of a gravity-fed feeder mouth with a battery-powered motor that releases feed from the device via opening feed doors at timed intervals such as but not limited to during daylight hours only. The mouth can attach to any gravity-fed deer feeder via an adaptor and fastener assembly.

### PRIOR ART

Looking at the prior art in this area starting with United States patent application Publication number 2023/0363351 to Christie, discloses a game feeder that is a unidirectional broadcast type that uses a motor driven spinner plate with radially outward vanes that discharges dry granular product from a storage tank therethrough a relatively narrow horizontal opening that prevent animal access to feed in the storage tank due to the opening and spinner plate.

Further, in the prior art in this area looking at United States patent application Publication number 2023/0232784 to Winn, discloses a game feeder that is has a species size specific feeder nozzle for allowed access to feed, this utilizes an adjustable partial door over the feed nozzle that is sized and configured to only allow a desired animal species to have access to the feed coming from the storage tank via a gravity-fed arrangement.

Continuing, in U.S. Pat. No. 11,980,169 to Eppink, teaches a deer feeder with an overhead storage vessel that gravity-feeds into a tube that terminates into a door that is electrically operated to have a closed state and an open state, the door electrical operation is controlled by circuitry that includes a close motion sensor and a far motion sensor that activate the door to open at a selected time, with data logging capability.

Further, in U.S. Pat. No. 11,856,925 to Sanderford, teaches an omnidirectional broadcast type deer feeder with an overhead storage vessel that gravity-feeds into a tube that terminates into a motor driven spinning tray, wherein the tray prevents animals from getting access to the feed manually.

What is needed for the present invention of the timed feed door device is the controlling of feed access to the animal through an automated door closing and opening system that can be set via time intervals or be activated by daylight/darkness to better target the desired animal feeding and to minimize feed waste.

### SUMMARY OF THE INVENTION

Broadly the present invention is the timed feed door device that is adapted to be removably engaged to and be in volumetric communication with an interior volume of a gravity-fed vessel that contains a dry granular product, the vessel is disposed in an exterior environment, the vessel also having an outlet port protrusion. The timed feed door device including a first surrounding sidewall that is about a longitudinal axis, the first surrounding sidewall having a first distal end portion and an opposing first proximal end portion with the longitudinal axis spanning therebetween, the first surrounding sidewall further including a first inner surface and an opposing first outer surface, the first surrounding sidewall also further including a first interior defined by the first inner surface, the first distal end portion, and the first proximal end portion, the first surrounding sidewall first distal end portion is adapted to removably engage the outlet port protrusion of the vessel such that the vessel interior volume is in communication with the first surrounding sidewall first interior.

The timed feed door device further includes a second surrounding sidewall that is about the longitudinal axis, the second surrounding sidewall having a first end portion and an opposing second end portion with the longitudinal axis spanning therebetween, the second surrounding sidewall further including a second inner surface and an opposing second outer surface, the first end portion having a first cover with a first aperture disposed therethrough, the first cover having a first cover inner surface and an opposing first cover outer surface, the second end portion having a second cover with a second cover inner surface and an opposing second cover outer surface. The second surrounding sidewall further including a second interior defined by the second inner surface, the first cover inner surface, and the second cover inner surface, the second interior further including a divider that separates the second interior into a primary second interior and a secondary second interior, wherein the first surrounding sidewall first proximal end portion is affixed to the first cover outer surface wherein the first interior and the primary second interior are in communication with one another therethrough the first aperture, the second surrounding sidewall further including a second aperture disposed therethrough from the second inner surface to the second outer surface, wherein the second aperture facilitates communication into the primary second interior.

The timed feed door device also further includes a third surrounding sidewall that is about a longwise axis, the third surrounding sidewall having a third proximal end portion and an opposing third distal end portion with the longwise axis spanning therebetween, the third surrounding sidewall further including a third inner surface and an opposing third outer surface, the third surrounding sidewall further including a third interior defined by the third inner surface, the third distal end portion, and the third proximal end portion, wherein the third surrounding sidewall third proximal end portion is affixed to the second surrounding sidewall outer surface such that the third interior is in communication with the second aperture and therefore the primary second interior.

The timed feed door device in addition further includes a door that has a pivotal attachment to the third surrounding sidewall third distal end portion on the third inner surface, wherein the pivotal attachment having a pivotal movement about the pivotal attachment, wherein the door in a door closed operational state separates the third interior from the exterior environment, and the door in a door open operational state facilitates communication between the third interior and the exterior environment. The door utilizing the pivotal movement between the closed and open operational states. Wherein ultimately, with the door in the open state there is communication from the vessel interior to the first interior, to the primary second interior, to the third interior, and finally to the exterior environment, thus operationally allowing the dry granular product to gravity flow from the vessel interior volume interior to the first interior, to the primary second interior, to the third interior, and finally to the exterior environment. When the door is in the closed state there is blocked communication from the vessel interior to the first interior, to the primary second interior, to the third interior to the exterior environment, thus operationally preventing the dry granular product to gravity flow from the vessel interior volume to the exterior environment and a means for selectable placing of the door in either the door open operational state or the door closed operational state.

### BRIEF DESCRIPTION OF DRAWINGS

FIG. 1 shows a side elevation view of the typical prior art installation of a gravity-fed deer feeder that uses a storage vessel mounted overhead on ground surface supports legs in this instance, that feeds deer feed in the form of a dry granular product into an outlet port that makes the deer feed available for the deer to consume, with the deer feed being available to the deer on a continuous non-stop basis.

FIG. 2 shows a side elevation view of an alternative version of the typical prior art installation of a gravity-fed deer feeder that uses a storage vessel mounted overhead on ground surface supports legs also in this instance, that feeds deer feed in the form of a dry granular product into an outlet port that has a spinning diffuser to distribute the deer feed in an omnidirectional manner, that makes the deer feed available for the deer to consume, this alternative version of the gravity-feed deer feeder also has the deer feed being available to the deer on a continuous non-stop basis.

FIG. 3 shows a side elevation view of the present invention being the gravity-fed deer feeder in the form of a timed feed door device that includes the storage vessel mounted overhead on ground surface supports legs in this instance, that feeds deer feed in the form of a dry granular product into an outlet port that makes the deer feed available for the deer to consume, with the deer feed only being available to the deer therethrough a door that has an open state and a closed state to only allow the deer feed to flow on a selectable timed basis, wherein FIG. 3 shows the door in a closed operational state.

FIG. 4 shows a side elevation view of the present invention being the gravity-fed deer feeder in the form of a timed feed door device that includes the storage vessel mounted overhead on ground surface supports legs in this instance, that feeds deer feed in the form of a dry granular product into an outlet port that makes the deer feed available for the deer to consume, with the deer feed only being available to the deer therethrough a door that has an open state and a closed state to only allow the deer feed to flow on a selectable timed basis, wherein FIG. 4 shows the door in an open operational state.

FIG. 5 shows a side elevation view of the present invention being the gravity-fed deer feeder in the form of a timed feed door device that includes the storage vessel mounted overhead on ground surface supports legs in this instance, that feeds deer feed in the form of a dry granular product into an outlet port that has an optional connector adaptor that is designed to removably engage a vessel with a flush outlet opening that makes the deer feed available for the deer to consume, with the deer feed only being available to the deer therethrough a door that has an open state and a closed state to only allow the deer feed to flow on a selectable timed basis, wherein FIG. 5 shows the door in a closed operational state.

FIG. 6 shows a side elevation view of the present invention being the gravity-fed deer feeder in the form of a timed feed door device that includes the storage vessel mounted overhead on ground surface supports legs in this instance, that feeds deer feed in the form of a dry granular product into an outlet port that has an optional connector adaptor that is designed to removably engage a vessel with a flush outlet opening that makes the deer feed available for the deer to consume, with the deer feed only being available to the deer therethrough a door that has an open state and a closed state to only allow the deer feed to flow on a selectable timed basis, wherein FIG. 6 shows the door in an open operational state.

FIG. 7 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall.

FIG. 8 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall that includes showing the ambient light sensor and the pivotal attachment of the door, plus the first aperture of the first cover is shown.

FIG. 9 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall, plus also shown in the door in the closed operational state.

FIG. 10 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall, plus also shown is the door in the open operational state.

FIG. 11 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall, plus also shown is the door in the closed operational state, further shown is the optional connector adaptor that is designed to removably engage the vessel with a flush outlet opening (not shown).

FIG. 12 shows an upper perspective view close-up detail of the present invention being of the gravity-fed deer feeder in the form of a timed feed door device that shows the first surrounding sidewall, the second surrounding sidewall, the third surrounding sidewall, and the fourth surrounding sidewall, plus also shown is the door in the open operational state, further shown is the optional connector adaptor that is designed to removably engage the vessel with a flush outlet opening (not shown).

FIG. 13 shows an upper perspective view of the optional connector adaptor that is designed to removably engage the vessel with a flush outlet opening (not shown), that adapts the vessel with the flush outlet opening to the first surrounding sidewall.

FIG. 14 shows a side elevation view of the optional connector adaptor that is designed to removably engage the vessel with a flush outlet opening (not shown), that adapts the vessel with the flush outlet opening to the first surrounding sidewall.

FIG. 15 shows a top view of the optional connector adaptor that is designed to removably engage the vessel with a flush outlet opening (not shown), that adapts the vessel with the flush outlet opening to the first surrounding sidewall.

FIG. 16 shows a bottom view of the optional connector adaptor that is designed to removably engage the vessel with a flush outlet opening (not shown), that adapts the vessel with the flush outlet opening to the first surrounding sidewall.

FIG. 17 shows an upper perspective end view of the fourth surrounding sidewall showing in particular the door in the closed operational state, with the second surrounding sidewall also shown.

FIG. 18 shows an upper perspective end view of the fourth surrounding sidewall showing in particular the door in the open operational state, with the second surrounding sidewall also shown.

FIG. 19 shows an upper perspective view of the fourth surrounding sidewall showing in particular a cut-away of the fourth surrounding sidewall in the vicinity of the door that is in the closed operational state the door in the closed operational state, with the dry granular product disposed within the fourth interior of the fourth surrounding sidewall, specifically showing how the door in the closed operational state blocks the flow of the dry granular product to the exterior environment for the deer to feed upon.

FIG. 20 shows an upper perspective view of the fourth surrounding sidewall showing in particular a cut-away of the fourth surrounding sidewall in the vicinity of the door that is in the closed operational state the door in the open operational state, with the dry granular product disposed within the fourth interior of the fourth surrounding sidewall, specifically showing how the door in the open operational state allows the flow of the dry granular product to the exterior environment for the deer to feed upon.

FIG. 21 shows a side elevation view close-up detail of the present invention being of the gravity-fed deer feeder in the form of a timed feed door device that shows the first surrounding sidewall, the second surrounding sidewall, the third surrounding sidewall, and the fourth surrounding sidewall, plus also shown disposed on the second surrounding sidewall is the first and second double drive pulleys that are mated to one another in a gear drive each having a limit switch protrusion to selectably clock rotation of the first and second double drive pulleys to the respectively the first and second toothed belts that in turn rotationally pivot the doors disposed within the third and fourth interiors respectively allowing the doors to move as between the open and closed operational states (doors not shown).

FIG. 22 shows an upper perspective view of the entire present invention being of the gravity-fed deer feeder in the form of a timed feed door device that shows the first surrounding sidewall, the second surrounding sidewall, the third surrounding sidewall, and the fourth surrounding sidewall, plus also shown disposed on the second surrounding sidewall is the first and second double drive pulleys that are mated to one another in a gear drive each having a limit switch protrusion to selectably clock rotation of the first and second double drive pulleys to the respectively the first and second toothed belts that in turn rotationally pivot the doors disposed within the third and fourth interiors respectively allowing the doors to move as between the open and closed operational states.

FIG. 23 shows an upper perspective view that is on the opposite side from FIG. 22 with the first and second surrounding sidewalls removed for pictorial clarity, that is to show the drive motor, plus the first and second tooth belt drive pulleys are shown that are of a smaller diameter than the first and second double drive pulley gear drives, as operationally the first and second double drive pulley gear drive set the selectable partial rotation of respectively the first and second toothed belt drive pulleys to move the doors from the open to closed operational states and to reverse the door from the closed to open operational state,

FIG. 24 shows an upper perspective view of the first and second surrounding sidewalls, with the third and fourth surrounding sidewalls shown also, FIG. 24 shows in particular the control circuitry and battery power supply of the gravity-fed deer feeder in the form of a timed feed door device with the control circuitry allowing select ability of the timing of the door open and closed states.

FIG. 25 shows an upper perspective view of the first and second surrounding sidewalls in particular, with the third and fourth surrounding sidewalls shown also, FIG. 24 shows in particular the second surrounding sidewall interior with the divider that splits the second surrounding sidewall into a primary second interior and a secondary second interior, wherein the secondary second interior houses the control circuitry and power supply and the primary second interior facilitates the dry granular product flow from the first surrounding sidewall to the third and fourth surrounding sidewall interiors respectively.

### DETAILED DESCRIPTION OF THE INVENTION

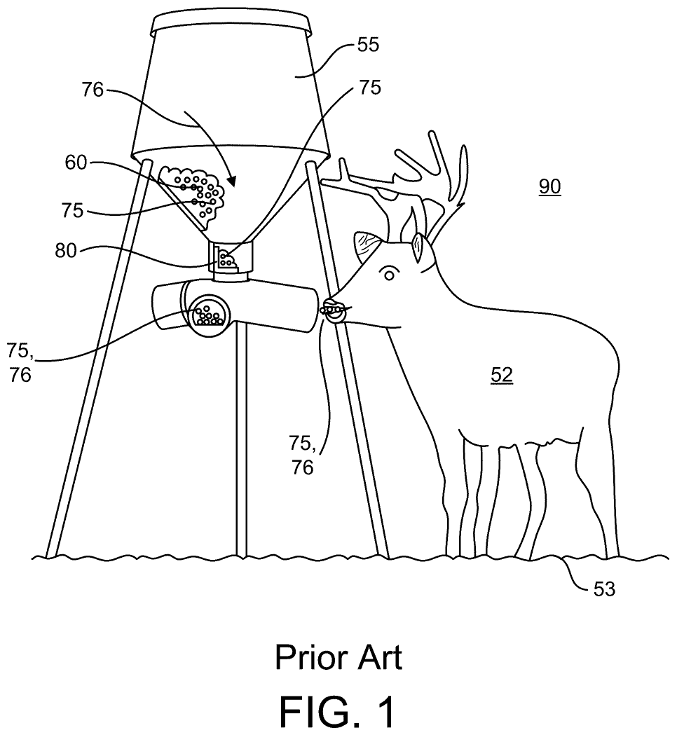

With initial reference to FIG. 1 shown is a side elevation view of the typical prior art installation of a gravity-fed deer feeder that uses a storage vessel 55 mounted overhead on the ground surface 53 supported by legs in this instance, that feeds deer feed in the form of a dry granular product 75 into an outlet port 75, 76 that makes the deer feed available for the deer 52 to consume, with the deer feed being available to the deer on a continuous non-stop basis time wise.

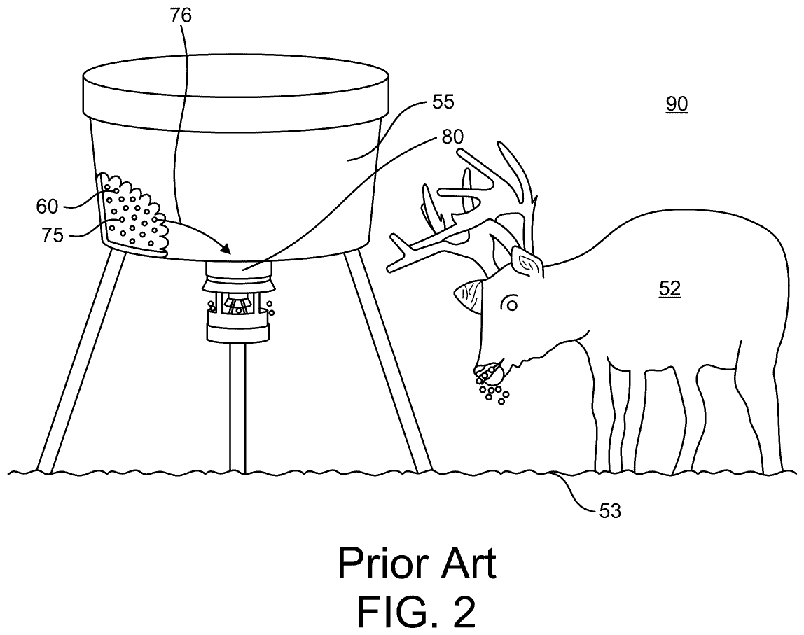

Continuing, FIG. 2 shows a side elevation view of an alternative version of the typical prior art installation of a gravity-fed deer feeder that uses a storage vessel 55 mounted overhead on the ground surface 53 supports legs also in this instance, that feeds deer feed in the form of a dry granular product 75 into an outlet port that has a spinning diffuser to distribute the deer feed 75 in an omnidirectional manner, that makes the deer feed 75 available for the deer 52 to consume, this alternative version of the gravity-feed deer feeder also has the deer feed 75 being available to the deer 52 on a continuous non-stop basis time wise.

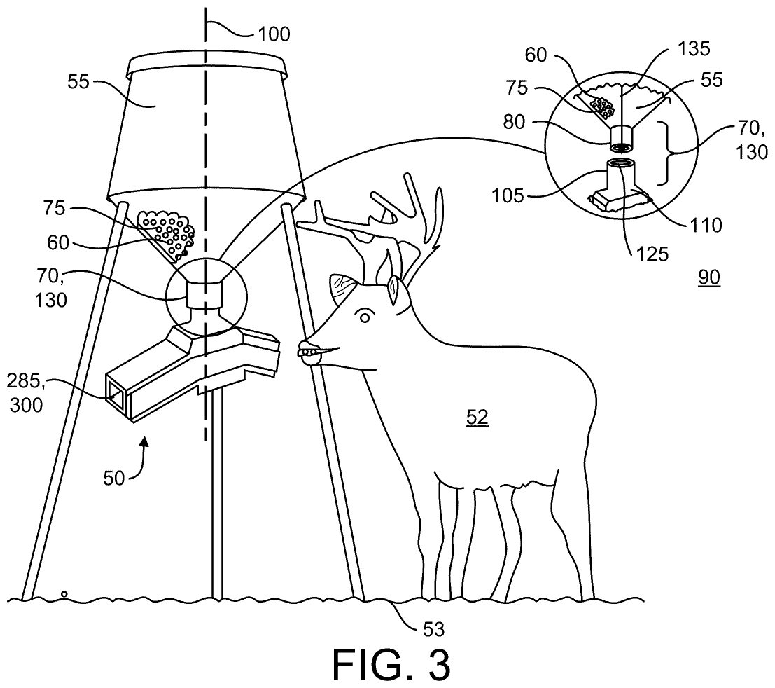

Further, FIG. 3 shows a side elevation view of the present invention being the gravity-fed deer feeder 50 in the form of a timed feed door device that includes the storage vessel 55 mounted overhead on the ground surface 53 supported by legs in this instance, that feeds deer feed in the form of a dry granular product 75 into an outlet port 80 that makes the deer feed 75 available for the deer 52 to consume, with the deer feed 75 only being available to the deer 52 therethrough a door 285 that has an open state 305 and a closed state 300 to only allow the deer feed 75 to flow on a selectable timed basis, wherein FIG. 3 shows the door 285 in a closed operational state 300.

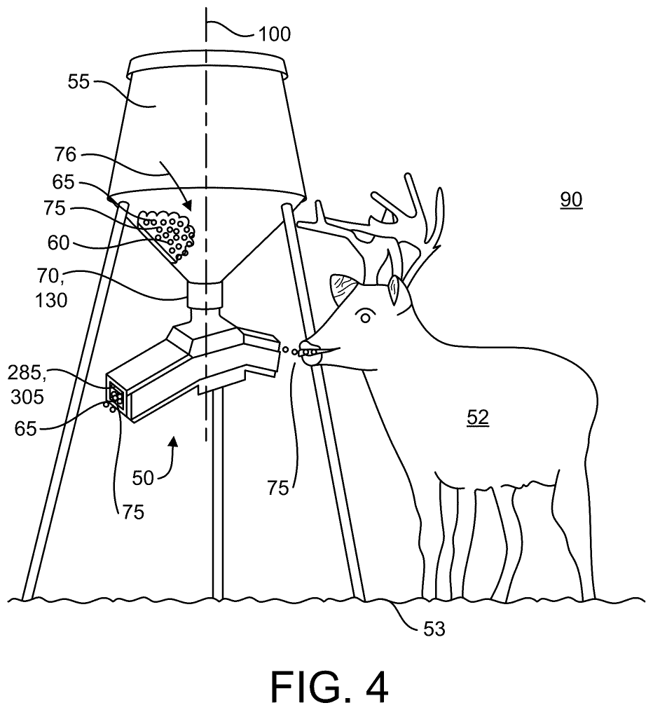

Next, FIG. 4 shows a side elevation view of the present invention being the gravity-fed deer feeder 50 in the form of a timed feed door device that includes the storage vessel 55 mounted overhead on the ground surface 53 supported by legs in this instance, that feeds deer feed in the form of a dry granular product 75 into an outlet port 80 that makes the deer feed 75 available for the deer 52 to consume, with the deer feed 75 only being available to the deer 52 therethrough the door 285 that has an open state 305 and a closed state 300 to only allow the deer feed 75 to flow on a selectable timed basis, wherein FIG. 4 shows the door 285 in an open operational state 305.

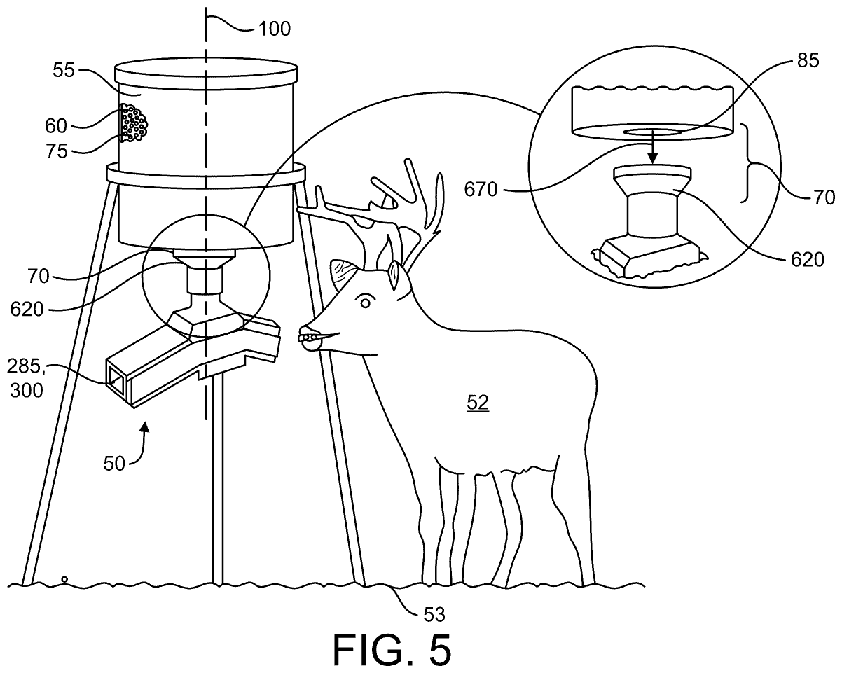

Moving onward, FIG. 5 shows a side elevation view of the present invention being the gravity-fed deer feeder 50 in the form of a timed feed door device that includes the storage vessel 55 mounted overhead on the ground surface 53 supported by legs in this instance, that feeds deer feed in the form of a dry granular product 75 into an outlet port 80 that has an optional connector adaptor 620 that is designed to removably engage a vessel with a flush outlet opening 85 that makes the deer feed 75 available for the deer 52 to consume, with the deer feed 75 only being available to the deer 52 therethrough the door 285 that has the open state 305 and the closed state 300 to only allow the deer feed 75 to flow on a selectable timed basis, wherein FIG. 5 shows the door 285 in a closed operational state 300.

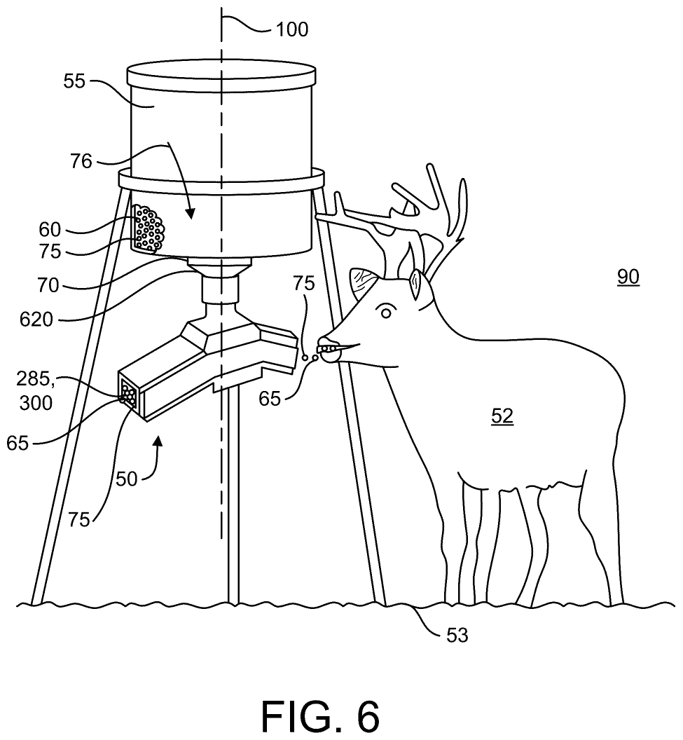

Continuing, FIG. 6 shows a side elevation view of the present invention being the gravity-fed deer feeder 50 in the form of a timed feed door device that includes the storage vessel 55 mounted overhead on the ground surface 53 supported by legs in this instance, that feeds deer feed in the form of a dry granular product 75 into an outlet port 80 that has an optional connector adaptor 620 that is designed to removably engage the vessel with a flush outlet opening 85 that makes the deer feed 75 available for the deer 52 to consume, with the deer feed 75 only being available to the deer 52 therethrough the door 285 that has the open state 305 and the closed state 300 to only allow the deer feed 75 to flow on a selectable timed basis, wherein FIG. 6 shows the door 285 in an open operational state 305.

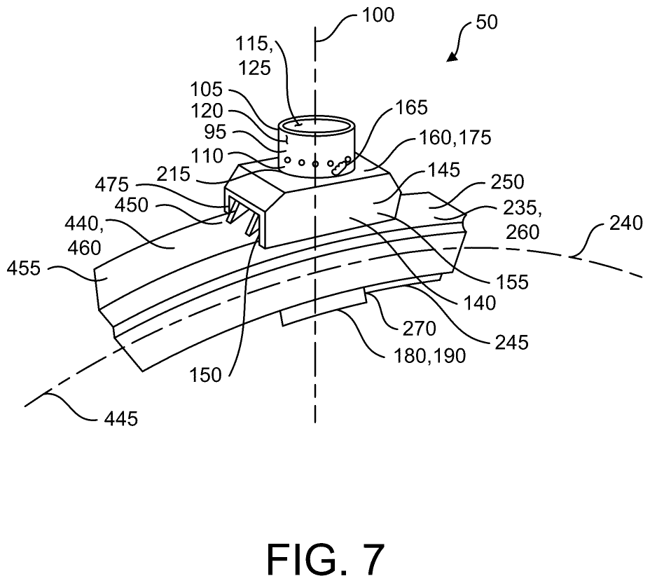

Further, FIG. 7 shows an upper perspective view close-up detail of the present invention being of the gravity-fed deer feeder 50 in the form of a timed feed door device that shows the first surrounding sidewall 95, the second surrounding sidewall 140, the third surrounding sidewall 235, and the fourth surrounding sidewall 440.

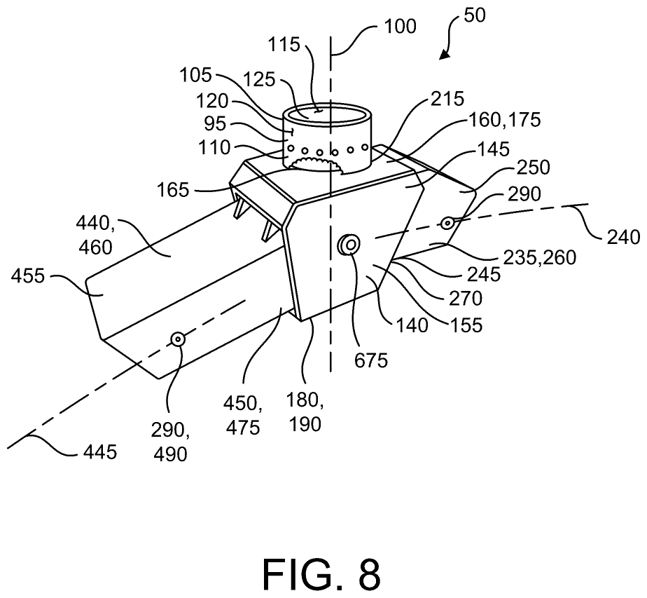

Next, FIG. 8 shows an upper perspective view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440 that includes showing the ambient light sensor 675 and the pivotal attachment 290 of the door 285, plus the first aperture 165 of the first cover 160 is shown.

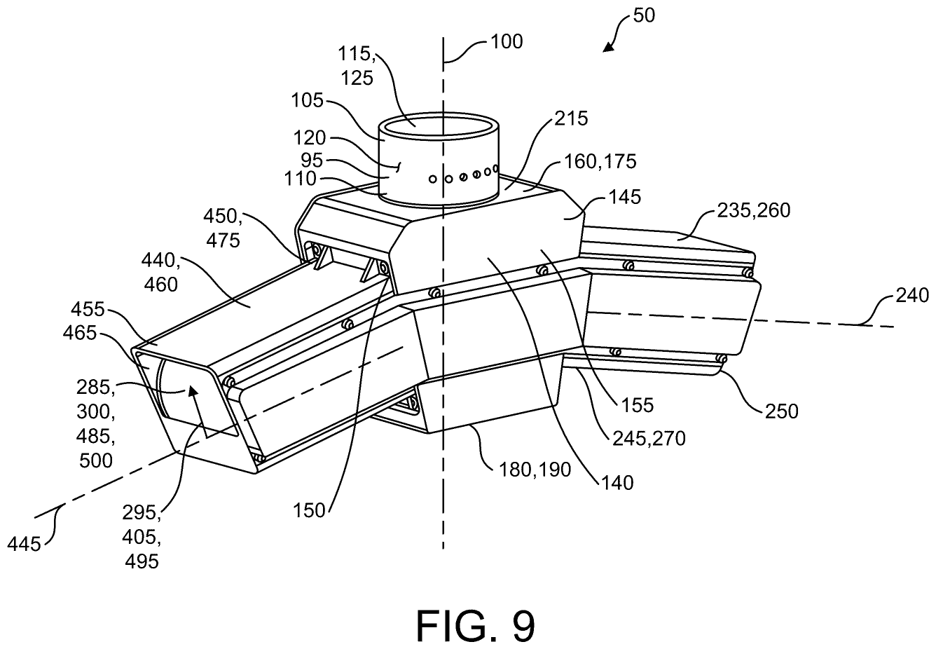

Continuing, FIG. 9 shows an upper perspective view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown in the door 285 in the closed operational state 300.

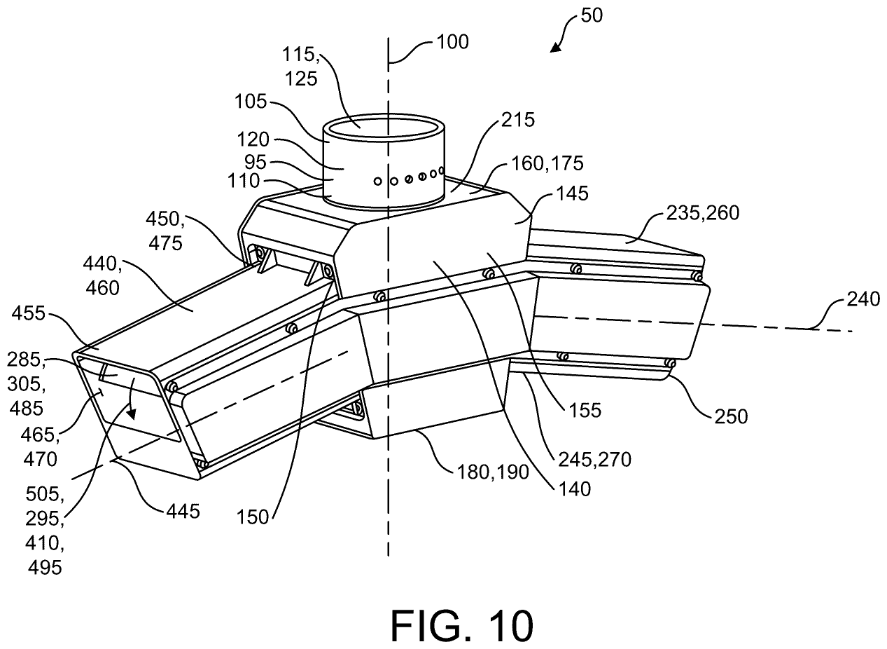

Further, FIG. 10 shows an upper perspective view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown is the door 285 in the open operational state 305.

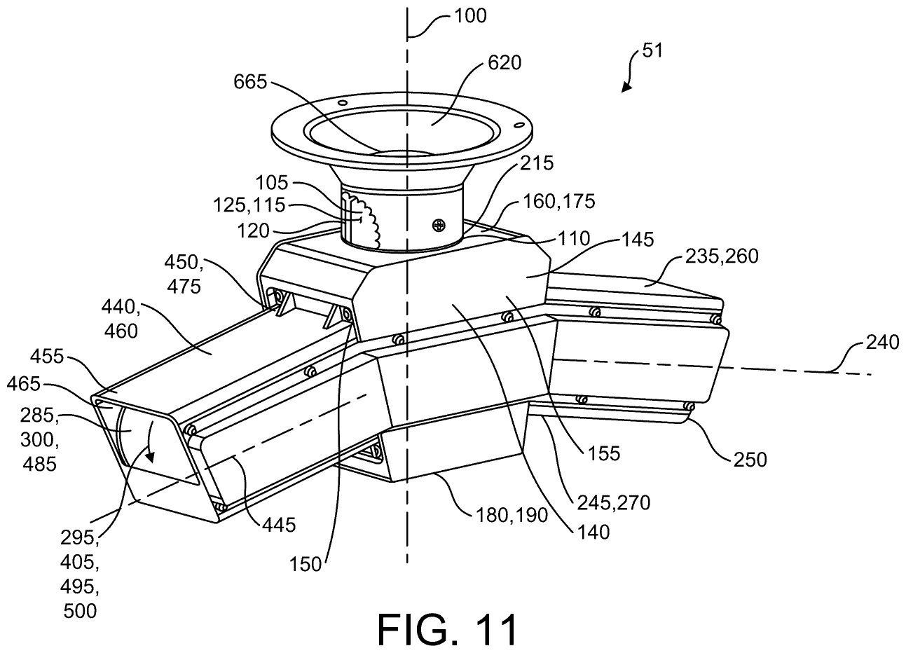

Moving onward, FIG. 11 shows an upper perspective view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown is the door 285 in the closed operational state 300, further shown is the optional connector adaptor 620 that is designed to removably engage the vessel 55 with a flush outlet opening 85 (not shown).

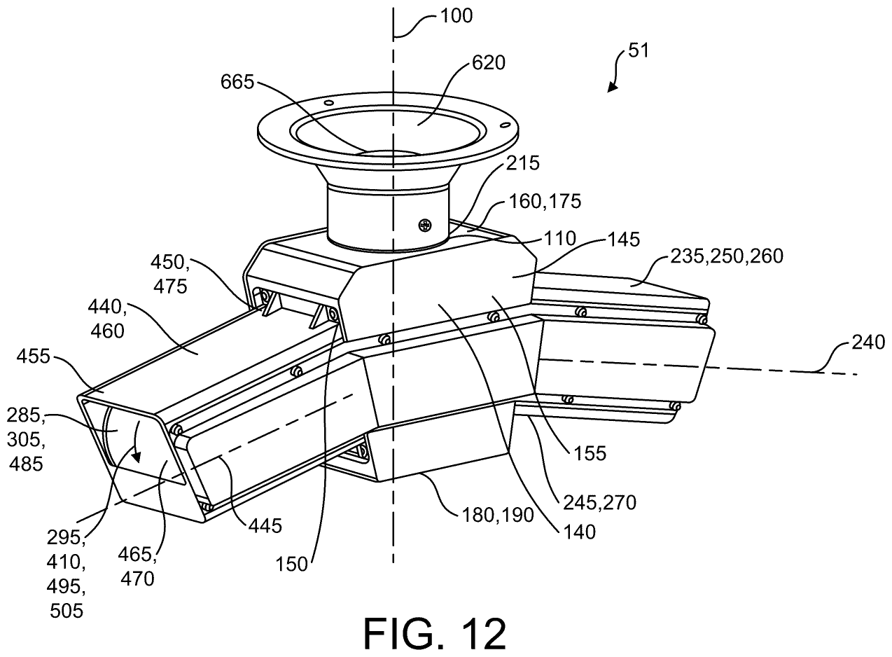

Next, FIG. 12 shows an upper perspective view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown is the door 285 in the open operational state 305, further shown is the optional connector adaptor 620 that is designed to removably engage the vessel 55 with a flush outlet opening 85 (not shown).

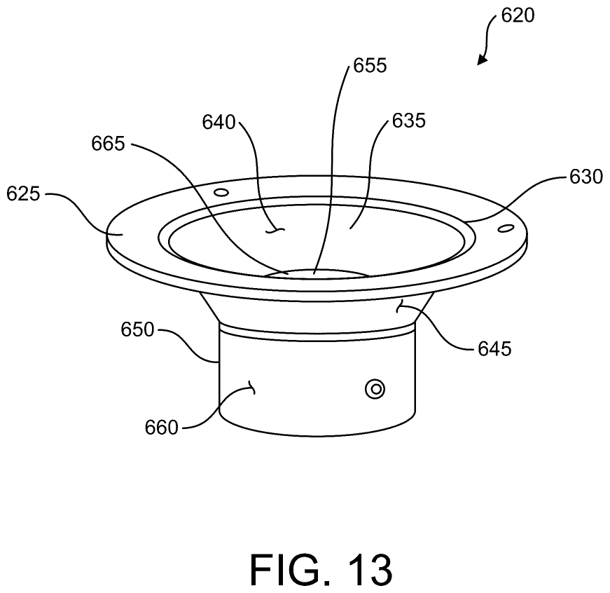

Also, FIG. 13 shows an upper perspective view of the optional connector adaptor 620 that is designed to removably engage the vessel 55 with a flush outlet opening 85 (not shown), that adapts the vessel 55 with the flush outlet opening 85 to the first surrounding sidewall 95.

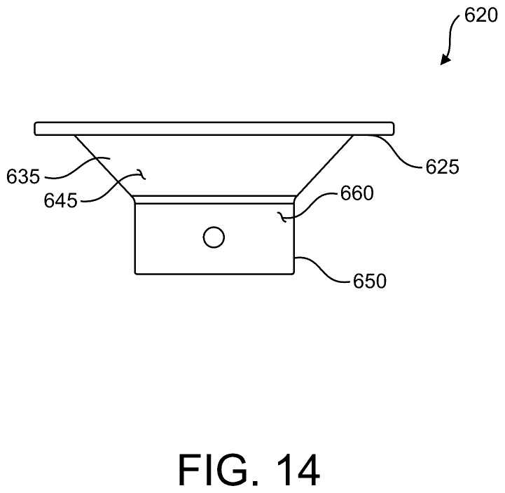

Further, FIG. 14 shows a side elevation view of the optional connector adaptor 620 that is designed to removably engage the vessel 55 with a flush outlet opening 85 (not shown), that adapts the vessel 55 with the flush outlet opening 85 to the first surrounding sidewall 95.

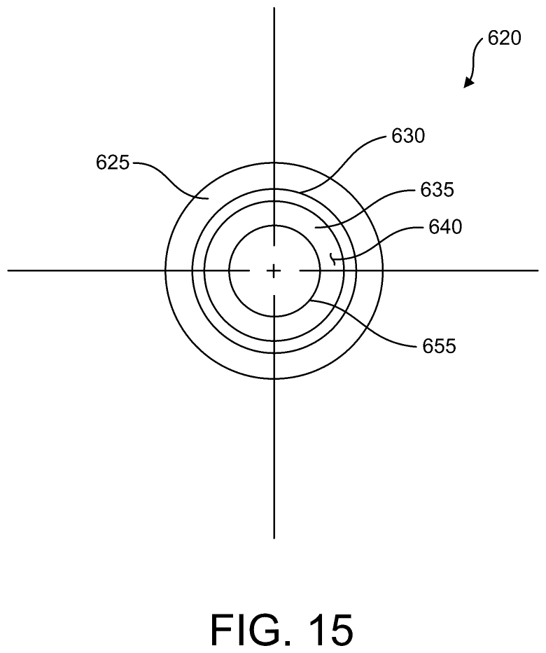

Continuing, FIG. 15 shows a top view of the optional connector adaptor 620 that is designed to removably engage the vessel 55 with a flush outlet opening 85 (not shown), that adapts the vessel 55 with the flush outlet opening 85 to the first surrounding sidewall 95.

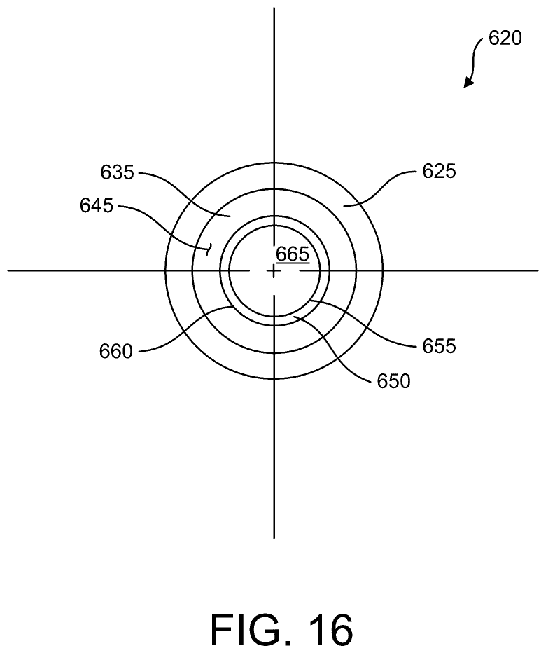

Further, FIG. 16 shows a bottom view of the optional connector adaptor 620 that is designed to removably engage the vessel 55 with a flush outlet opening 85 (not shown), that adapts the vessel 55 with the flush outlet opening 85 to the first surrounding sidewall

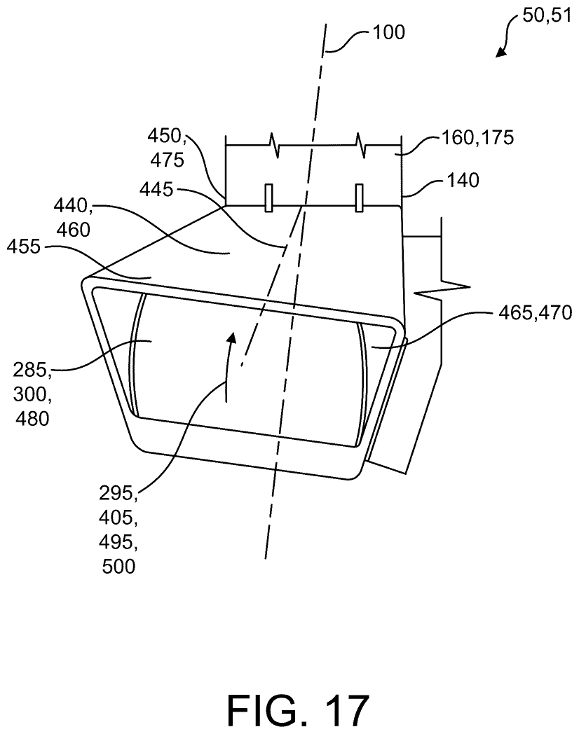

Also, FIG. 17 shows an upper perspective end view of the fourth surrounding sidewall 440 showing in particular the door 285 in the closed operational state 300, with the second surrounding sidewall 140 also shown.

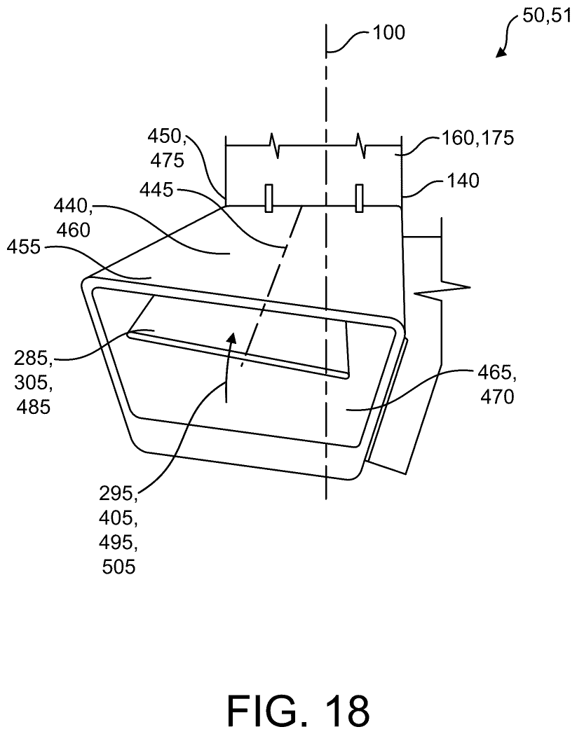

Next, FIG. 18 shows an upper perspective end view of the fourth surrounding sidewall 440 showing in particular the door 285 in the open operational state 305, with the second surrounding sidewall 140 also shown.

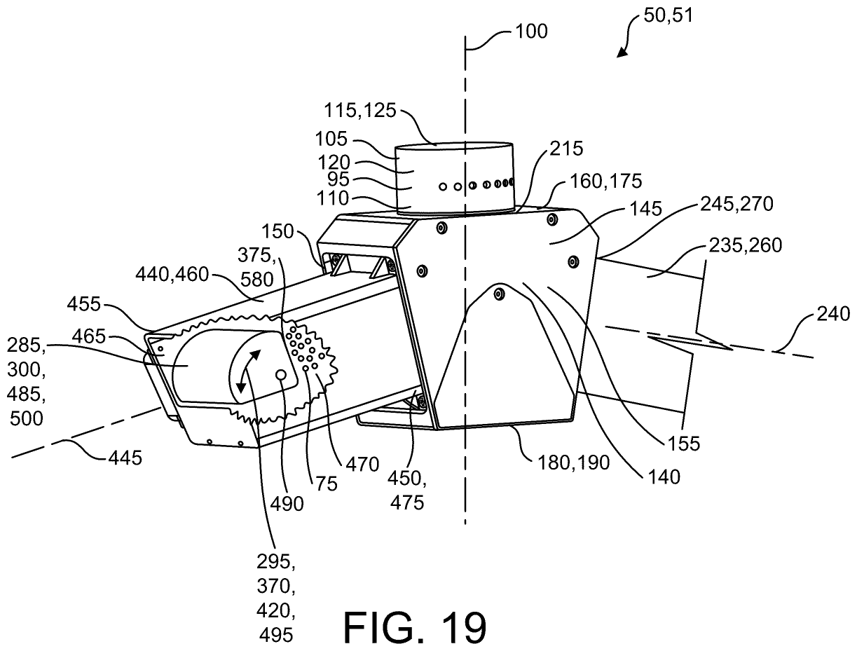

Continuing, FIG. 19 shows an upper perspective view of the fourth surrounding sidewall 440 showing in particular a cut-away of the fourth surrounding sidewall 440 in the vicinity of the door 285 that is in the closed operational state 300 the door 285 in the closed operational state 300, with the dry granular product 75 disposed within the fourth interior 470 of the fourth surrounding sidewall 440, specifically showing how the door 285 in the closed operational state 300 blocks the flow of the dry granular product 75 to the exterior environment 90 for the deer 52 to feed upon.

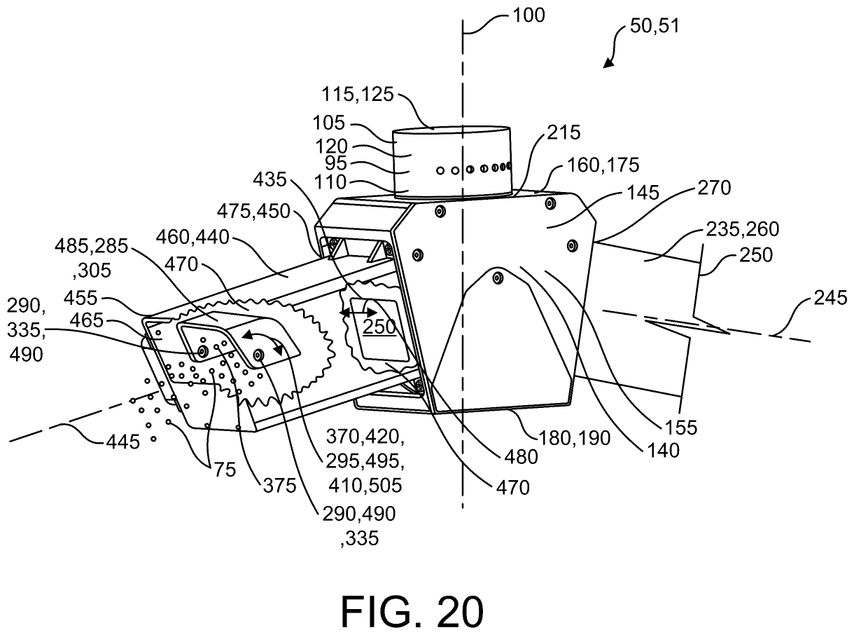

Further, FIG. 20 shows an upper perspective view of the fourth surrounding sidewall 440 showing in particular a cut-away of the fourth surrounding sidewall 440 in the vicinity of the door 285 that is in the closed operational state 300 the door 285 in the open operational state 305, with the dry granular product 75 disposed within the fourth interior 470 of the fourth surrounding sidewall 440, specifically showing how the door 285 in the open operational state 305 allows the flow of the dry granular product 75 to the exterior environment 90 for the deer 52 to feed upon.

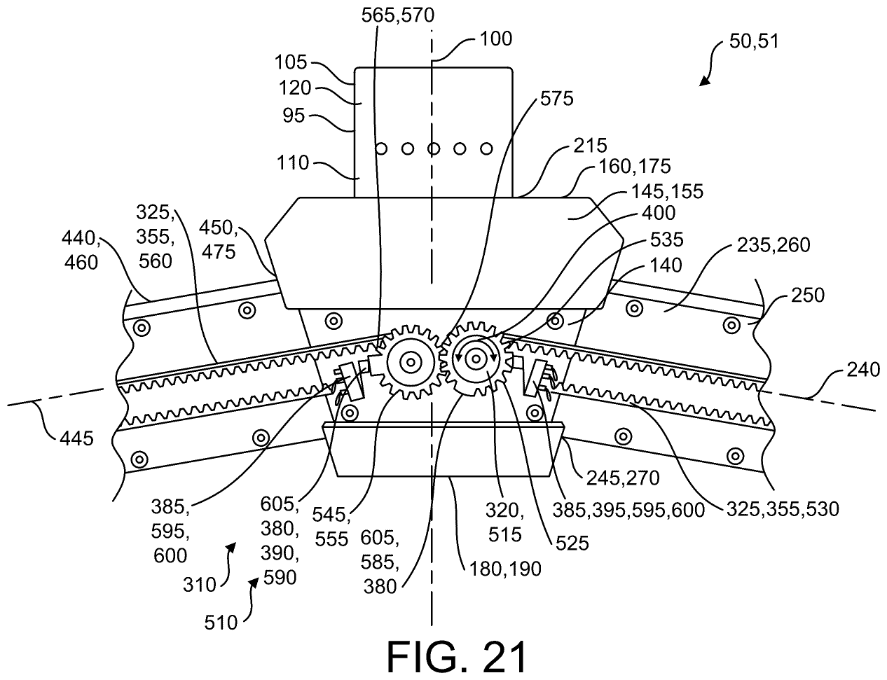

Next, FIG. 21 shows a side elevation view close-up detail of the present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown disposed on the second surrounding sidewall 140 is the first 515 and second 545 double drive pulleys that are mated to one another in a gear drive 575 each having a limit switch protrusion 380, 585, 590, 600, 605 to selectably clock rotation of the first 515 and second 545 double drive pulleys to the respectively the first 530 and second 560 toothed belts that in turn rotationally pivot 370 the doors 285 disposed within the third 265 and fourth 470 interiors respectively allowing the doors 285 to move as between the open 305 and closed 300 operational states (doors not shown).

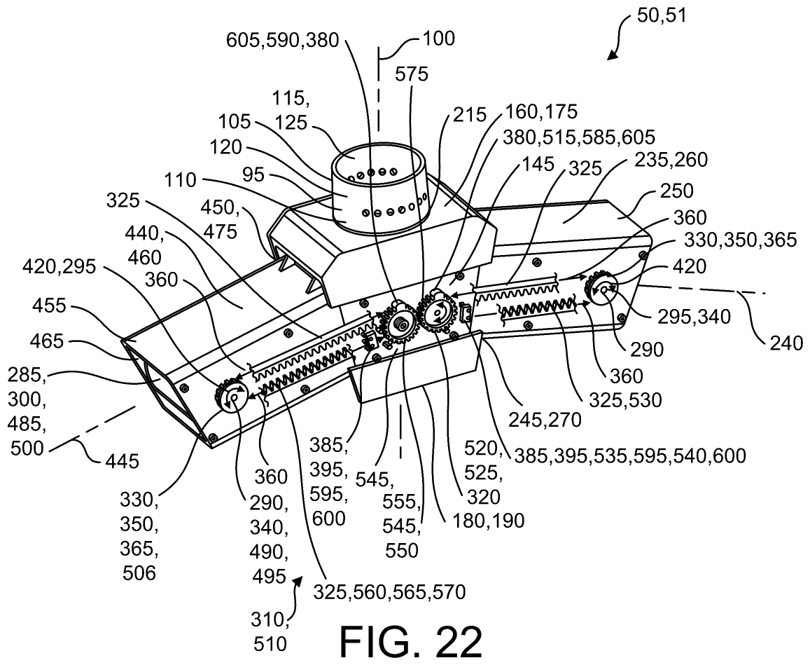

Further, FIG. 22 shows an upper perspective view of the entire present invention being of the gravity-fed deer feeder in the form of a timed feed door device 50 that shows the first surrounding sidewall 95, the second surrounding sidewall 140, the third surrounding sidewall 235, and the fourth surrounding sidewall 440, plus also shown disposed on the second surrounding sidewall 140 is the first 515 and second 545 double drive pulleys that are mated to one another in a gear drive 575 each having a limit switch protrusion 380, 585, 590, 600, 605 to selectably clock rotation of the first 515 and second 545 double drive pulleys to the respectively the first 530 and second 560 toothed belts that in turn rotationally pivot 370 the doors 285 disposed within the third 265 and fourth 470 interiors respectively allowing the doors 285 to move as between the open 305 and closed 300 operational states.

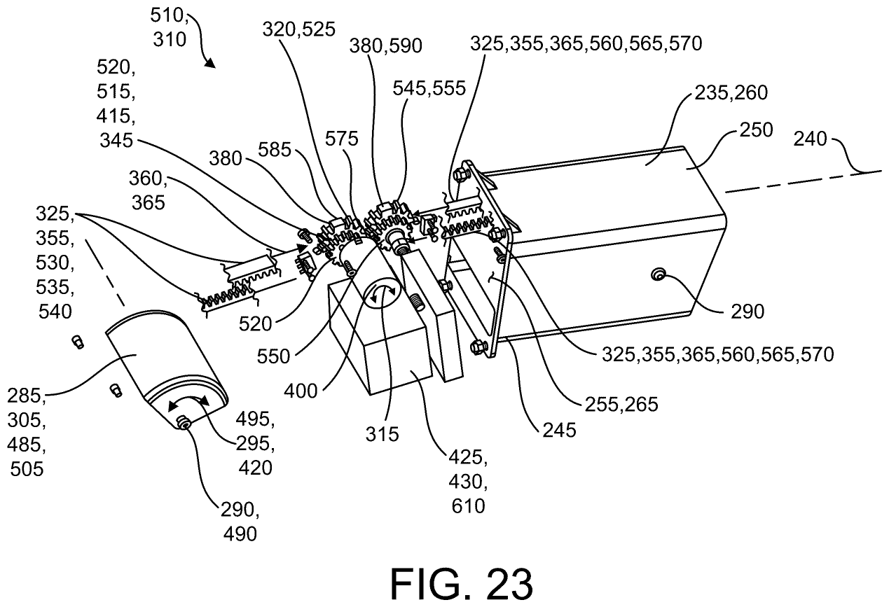

Moving forward, FIG. 23 shows an upper perspective view that is on the opposite side from FIG. 22 with the first 95 and second 140 surrounding sidewalls removed for pictorial clarity, that is to show the drive motor 315, plus the first 520 and second 550 toothed belt drive pulleys are shown that are of a smaller diameter than the first 515 and second 545 double drive pulley gear drives, as operationally the first 515 and second 545 double drive pulley gear drive set the selectable partial rotation of respectively the first 520 and second 550 toothed belt drive pulleys to move the doors 285 from the open 305 to closed 300 operational states and to reverse the door 285 from the closed 300 to open 305 operational state.

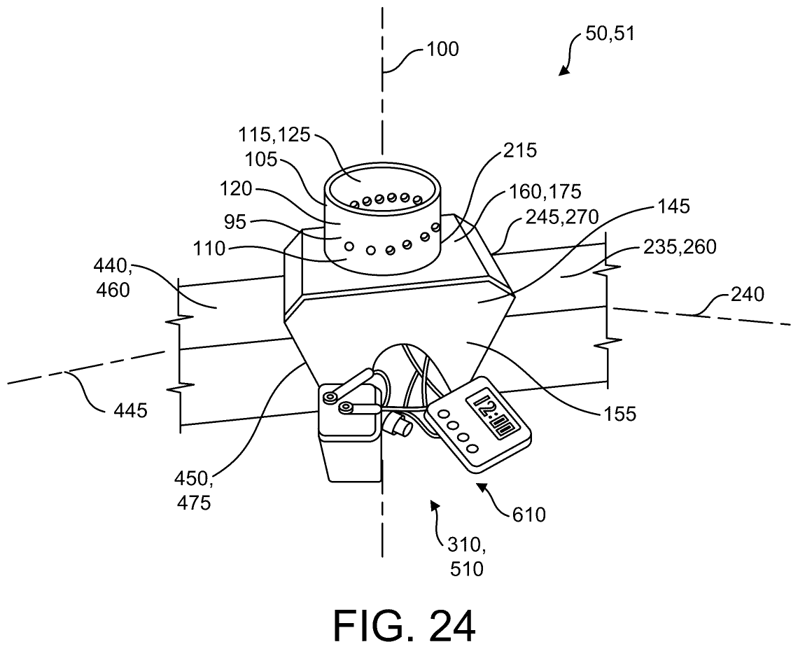

Continuing, FIG. 24 shows an upper perspective view of the first 95 and second 140 surrounding sidewalls in particular, with the third 235 and fourth 440 surrounding sidewalls shown also, FIG. 24 shows in particular the control circuitry 610 and battery power supply of the gravity-fed deer feeder in the form of a timed feed door device 50 with the control circuitry 610 allowing select ability of the timing of the door 285 open 305 and closed 300 states.

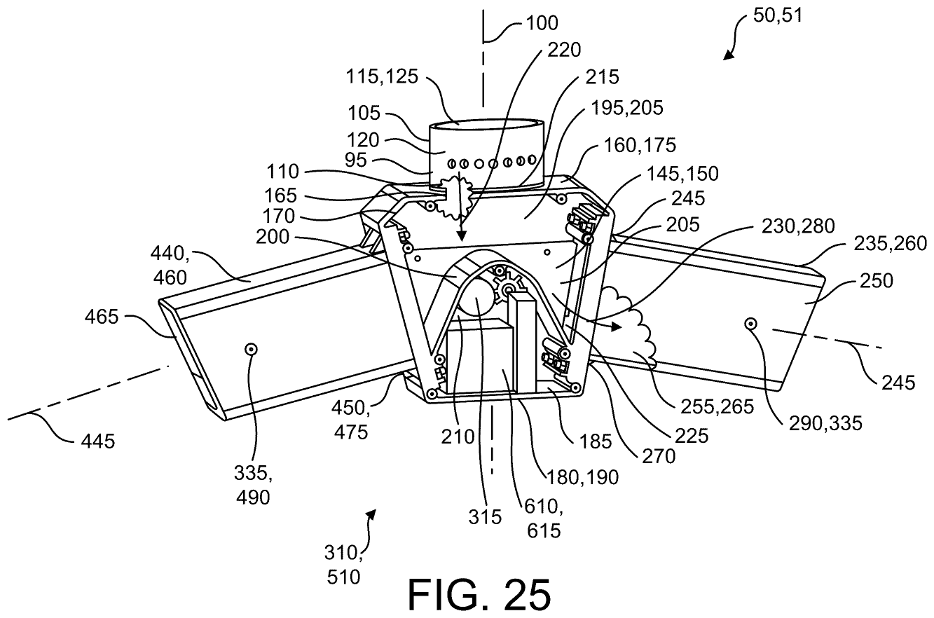

Next, FIG. 25 shows an upper perspective view of the first 95 and second 140 surrounding sidewalls in particular, with the third 235 and fourth 440 surrounding sidewalls shown also, FIG. 24 shows in particular the second surrounding sidewall interior 195 with the divider 200 that splits the second surrounding sidewall 140 into a primary second interior 205 and a secondary second interior 210, wherein the secondary second interior 210 houses the control circuitry 610 and power supply and the primary second interior 205 facilitates the dry granular product 75 flow 220 from the first surrounding sidewall 95 to the third 235 and fourth 440 surrounding sidewall interiors 265, 470 respectively.

Broadly in looking at FIGS. 1 to 25, the present invention is the timed feed door device 50 that is adapted to be removably engaged 70 to and be in volumetric communication 65 with an interior volume 60 of a gravity-fed vessel 55 that contains a dry granular product 75, the vessel 55 is disposed in an exterior environment 90, the vessel 55 having an outlet port protrusion 85. The timed feed door device 50 including a first surrounding sidewall 95 that is about a longitudinal axis 100, the first surrounding sidewall 95 having a first distal end portion 105 and an opposing first proximal end portion 110 with the longitudinal axis 100 spanning therebetween. The first surrounding sidewall 95 further including a first inner surface 115 and an opposing first outer surface 120, the first surrounding sidewall 95 also further including a first interior 125 defined by the first inner surface 115, the first distal end portion 105, and the first proximal end portion 110, the first surrounding sidewall 95 first distal end portion 105 is adapted to removably engage 70, 130 the outlet port protrusion 80 of the vessel 55 such that the vessel interior volume 60 is in communication 135 with the first surrounding sidewall first interior 125, see in particular FIGS. 3 to 6.

The timed feed door device 50 further includes a second surrounding sidewall 140 that is about the longitudinal axis 100, the second surrounding sidewall 140 having a first end portion 145 and an opposing second end portion with the longitudinal axis 100 spanning therebetween, the second surrounding sidewall 140 further including a second inner surface 150 and an opposing second outer surface 155, the first end portion 145 having a first cover 160 with a first aperture 165 disposed therethrough, the first cover 160 having a first cover inner surface 170 and an opposing first cover outer surface 175, the second end portion having a second cover 180 with a second cover inner surface 185 and an opposing second cover outer surface 190. The second surrounding sidewall 140 further including a second interior 195 defined by the second inner surface 150, the first cover inner surface 170, and the second cover inner surface 185, the second interior 195 further including a divider 200 that separates the second interior 195 into a primary second interior 205 and a secondary second interior 210. Wherein the first surrounding sidewall 95 first proximal end portion 110 is affixed 215 to the first cover outer surface 175 wherein the first interior 125 and the primary second interior 205 are in communication 220 with one another therethrough the first aperture 165, the second surrounding sidewall 140 further including a second aperture 225 disposed therethrough from the second inner surface 150 to the second outer surface 155, wherein the second aperture 225 facilitates communication 230 into the primary second interior 205, see in particular FIG. 25.

The timed feed door device 50 also further includes a third surrounding sidewall 235 that is about a longwise axis 240, the third surrounding sidewall 235 having a third proximal end portion 245 and an opposing third distal end portion 250 with the longwise axis 240 spanning therebetween, the third surrounding sidewall 235 further including a third inner surface 255 and an opposing third outer surface 260, the third surrounding sidewall 235 further including a third interior 265 defined by the third inner surface 255, the third distal end portion 250, and the third proximal end portion 245, wherein the third surrounding sidewall 235 third proximal end portion 245 is affixed 270 to the second surrounding sidewall 140 outer surface 155 such that the third interior 265 is in communication 280 with the second aperture 225 and therefore the primary second interior 205, see FIGS. 7 to 12, 20, 23, and 25.

The timed feed door device 50 in addition further includes a door 285 that has a pivotal attachment 290 to the third surrounding sidewall 235 third distal end portion 250 on the third inner surface 255, wherein the pivotal attachment 290 having a pivotal movement 295 about the pivotal attachment 290, wherein the door 285 in a door closed operational state 300 separates the third interior 265 from the exterior environment 90, and the door 285 in a door open operational state 305 facilitates communication between the third interior 265 and the exterior environment 90, the door 285 utilizing the pivotal movement 295 between the closed 300 and open 305 operational states, see FIGS. 19 and 20. Wherein ultimately with the door 285 in the open state 305 there is communication from the vessel interior 60 to the first interior 125, to the primary second interior 205, to the third interior 265, and finally to the exterior environment 90, thus operationally allowing the dry granular product 75 to gravity flow from the vessel 55 interior volume interior 60 to the first interior 125, to the primary second interior 205, to the third interior 265, and finally to the exterior environment 90, see FIGS. 4, 6, 18, and 20. When the door 285 is in the closed state 300 there is blocked communication from the vessel 55 interior 60 to the first interior 125, to the primary second interior 205, to the third interior 265 to the exterior environment 90, thus operationally preventing the dry granular product 75 to gravity flow from the vessel 55 interior volume 60 to the exterior environment 90 and a means 310 for selectable placing of the door 285 in either the door 285 open operational state 305 or the door closed operational state 300.

An option timed feed door device 50, wherein the means 310 for selectable placing of the 285 door in either the door 285 open operational state 305 or the door closed operational state 300 is constructed of a motor 315 rotationally affixed to a motor drive pulley 320 that drives a belt 325 that in turn drives a door rotation pulley 330 that is rotationally engaged to a door pivot shaft 335 that comprises the door 285 pivotal attachment 290, 490, see FIGS. 12 to 25.

A further option for the timed feed door device 50, is wherein the motor 315 drive pulley 320, the belt 325, and the door rotation pulley 330 are constructed of a toothed belt 355 system that comprises the motor drive pulley 320 having a first outer periphery with spaced apart teeth 345 disposed upon and a door rotation pulley 330 outer periphery with spaced apart teeth 350 disposed upon it, and a toothed belt 355 with spaced apart teeth disposed upon an internal side of the toothed belt 355, wherein the motor drive pulley 320 outer periphery 345, the belt 355, and the door 285 rotation pulley 350 are mateably engaged 360 to one another through the toothed belt system 355 to operationally result in the motor drive pulley 320 and the door rotation pulley 350 being in rotational lockstep 365 through the toothed belt 355 to one another to better overcome a door 285 pivotal rotational resistance 370 about the door pivotal attachment 290 due to the friction 375 of the dry granular product 75 as against the door 285, see FIGS. 12 to 25.

Continuing, an option for the timed feed door device 50, wherein the motor 315 drive pulley 320 further comprises a radially outward protrusion 380 that radially extends outward beyond the motor drive pulley 320, further included is a limit switch 385 that is disposed upon a portion of the second surrounding sidewall 140 second outer surface 155 and positioned to momentarily contact 390 the radially outward protrusion 380, 585, 590 during a rotation 400 of the motor drive pulley 320, wherein operationally the limit switch 385 disrupts power to the motor 315 when the radially outward protrusion 380, 585, 590 contacts the limit switch 385 to stop the pivotal movement 290 in either of the door 285 moving 405 toward the open operational state 305 or the door 285 moving 410 toward the closed operational state 300, see FIGS. 21 to 25.

A further option for the timed feed door device 50, is wherein the motor 315 drive pulley 320 first outer periphery 345 has a circumferential distance that is about equal 415 to the door 285 rotation pulley 330 outer periphery 350 circumferential distance to operationally result in about one rotation of the motor 315 drive pulley 320 to about one rotation of the door rotation pully 330 to operationally have the limit switch 385 activate once per rotation of the motor 315 drive pulley 320 while the door 285 rotation pulley 330 moves about one-quarter rotation 420 for the pivotal movement 290 of the door 285 between the open 305 and closed 300 states, the limit switch 385 further including control circuitry 425 to reverse motor 315 rotational direction each time the limit switch 385 is activated to operationally initiate the door 285 pivotal movement 290 in the selectable manner for placing the door 285 in either of the door 285 open operational state 305 or the door 285 in the closed operational state 300, again see FIGS. 21 to 25.

A continuing option for the timed feed door device 50, wherein the limit switch 385 control circuitry 425 further includes circuitry 430 that is selected from the group consisting of timing circuitry or ambient light sensing circuitry 675 to facilitate the selectable manner for placing the door 285 in either of the door 285 open operational state 305 or the door 285 in the closed operational state 300 to be on a selectable time window, see FIGS. 8 and FIGS. 21 to 25.

Another option for the timed feed door device 50, is wherein the second surrounding sidewall 140 further comprises a third aperture 435 approximately oppositely positioned from the second aperture 225 about the longitudinal axis 100, in addition further comprising a fourth surrounding sidewall 440 that is about a lengthwise axis 445. The fourth surrounding sidewall 440 having a fourth proximal end portion 450 and an opposing fourth distal end portion 455 with the lengthwise axis 445 spanning therebetween. The fourth surrounding sidewall 440 further including a fourth inner surface 465 and an opposing fourth outer surface 460, the fourth surrounding sidewall 440 further including a fourth interior 470 defined by the fourth inner surface 465, the fourth distal end portion 455, and the fourth proximal end portion 450, wherein the fourth surrounding sidewall 440 fourth proximal end portion 450 is affixed 475 to the second surrounding sidewall 140 outer surface 155 in a position substantially opposing the third surrounding sidewall 235 about the longitudinal axis 100, such that the fourth interior 470 is in communication 480 with the third aperture 435 and therefore the primary second interior 205. Also further comprising an ancillary door that has an ancillary pivotal attachment to said fourth surrounding sidewall fourth distal end portion on said fourth inner surface. Wherein the ancillary pivotal attachment 490 having an ancillary pivotal movement 495 about the ancillary pivotal attachment 490, wherein the ancillary door 485 in an ancillary door 485 closed operational state 500 separates the fourth interior 470 from the exterior environment 90, and the ancillary door 485 in an ancillary door 485 open operational state 505 facilitates communication between the fourth interior 470 and the exterior environment 90. The ancillary door 485 utilizing the ancillary pivotal movement 495 between the closed 500 and open 505 operational states, wherein ultimately with the ancillary door 485 in the open state 505 there is communication from the vessel 55 interior 60 to the first interior 125, to the primary second interior 205, to the fourth interior 470, and finally to the exterior environment 90. Thus operationally allowing the dry granular product 75 to gravity flow from the vessel 55 interior volume interior 60 to the first interior 125, to the primary second interior 205, to the fourth interior 470, and finally to the exterior environment 90, and when the ancillary door 485 is in the closed state 500 there is blocked communication from the vessel 55 interior 60 to the first interior 125, to the primary second interior 205, to the fourth interior 470 to the exterior environment 90. Thus operationally preventing the dry granular product 75 to gravity flow from the vessel 55 interior volume 60 to the exterior environment 90, further a means 510 for selectable placing of the ancillary door 485 in either the ancillary 485 door open operational state 505 or the ancillary door 485 closed operational state 500, see FIGS. 3 to 25.

Another option for the timed feed door device 50, being wherein the means 510 for selectable placing of the door 285 and the ancillary door 485 in either the door 285 and the ancillary door 485 open operational states 305, 505 or the door 285 and the ancillary door 485 closed operational states 300, 500 are combined and constructed of a motor 315 rotationally affixed to a first double drive pulley 515 that has larger first gear drive pulley 525 with an adjacent concentrically positioned smaller first toothed belt drive pulley 520, wherein the first gear drive pulley 525 has a second outer periphery with gear teeth disposed upon and the first toothed belt drive pulley has a first outer periphery 520 with a spaced apart toothed belt drive teeth disposed upon and a door 485 rotation pulley outer periphery 506 with spaced apart teeth disposed upon, and a first toothed belt 530 with spaced apart teeth disposed upon an internal side of the first toothed belt 530, wherein the motor 315 first toothed belt drive pulley 520, the first toothed belt 530, and the door 485 rotation pulley 350 are mateably engaged 535 to one another through a first toothed belt system to operationally result in the motor 315 first toothed belt drive pulley 520 and the door rotation pulley 350 being in rotational lockstep 540 through the first toothed belt 530 to one another to better overcome a door 485 pivotal rotational 295 resistance about the door pivotal attachment 290 due to the friction 370 of the of the dry granular product 75 as against the door 285, 485. Plus further comprising a matching second of the first double drive pulley 515, wherein the second double drive pulley 545 is rotationally gear drive mated through a third outer periphery 555 with gear teeth disposed upon the third outer periphery 555 to the second outer periphery 525 with the gear teeth such that operationally the motor 315 drives both first 515 and second 545 double drive pulleys, the second double drive pulley 545 includes an adjacent concentrically positioned smaller second toothed belt drive pulley 550, the second toothed belt drive pulley 545 has a fourth outer periphery 550 with spaced apart toothed belt drive teeth disposed upon and an ancillary door rotation pulley 506 outer periphery with spaced apart teeth disposed upon, and a second toothed belt 560 with spaced apart teeth disposed upon an internal side of the second toothed belt 560, wherein the second toothed belt 560 drive pulley 550, the second tooth belt 560, and the ancillary door 485 rotation pulley 506 are mateably engaged 565 to one another through a second toothed belt system. This is to operationally result in the second toothed belt 560 drive pulley 550 and the ancillary door 485 rotation pulley 506 being in rotational lockstep 570 through the second toothed belt 560 to one another to better overcome an ancillary door 485 pivotal rotational resistance 580 about the ancillary door 485 pivotal attachment 490 due to the friction 370 of the of the dry granular product 75 as against the ancillary door 485, see in particular FIGS. 21 to 23, and FIG. 19.

A continuing option for the timed feed door device 50, as wherein the first 515 and second 545 double drive pulleys each further comprise a respective first 585 and a second 590 radially outward protrusions that radially extend outward beyond the motor 315 drive pulley 320 being respectively disposed upon the second outer periphery 525 and the third outer periphery 555, further included are a pair of limit switches 595 that are disposed upon a portion of the second surrounding sidewall 140 second outer surface 155 and positioned to have each one of the pair of limit switches 595 be adjacent to each of the second 525 and third 555 outer peripheries and are positioned such that they are symmetric 600 in an opposed relationship about the first 515 and second 545 double drive pulleys to one another, to have each limit switch 385 momentarily contact each of the first 585 and second 590 radially outward protrusions during a rotation of the first 515 and second 545 double drive pulleys. Further there is a rotational clocking position as between the second 525 and third 555 outer peripheries respective gears that are meshed such that the first 585 and the 590 second radially outward protrusions are clocked apart in a non-symmetric manner 605 to differentiate at what point in rotational position of the first 515 and second 545 double drive pulleys as each limit switch 385 is activated when the first 585 or second 590 radially outward protrusions rotates into position to contact each of the limit switches 385 at a different point in time. This results in each limit switch 385 being activated independently with a singular unique clock position of each of the first 585 and a second 590 radially outward protrusions means that the pair of limit switches 595 taken together activate with precision on the clocking of either of the first 585 or second 590 radially outward protrusions, the pair of limit switches 595 further including control circuitry 610 to reverse motor 315 rotational direction each time the pair of limit switches 595 are activated to positively confirm a rotational clocking position of the first 515 and second 545 double drive pulleys that positively indicates both the door 285 and the ancillary door 485 open operational state 305, 505 or closed 300, 500 operational state. This is to operationally initiate the door 285 and the ancillary door 485 pivotal movement 295, 495 in the selectable manner for placing the door 285 and the ancillary door 485 in either of the door open operational state 305, 505 or the door in the closed operational state 300, 500, see in particular FIGS. 21 to 25, and FIGS. 17 to 20, and FIGS. 3 to 12.

A further option for the timed feed door device 50, is wherein the pair of limit switches 595 control circuitry 610 further includes circuitry 615 that is selected from the group consisting of timing circuitry or ambient light sensing circuitry 675 to facilitate the selectable manner for placing the doors 285, 485 in either of the door open operational state 305, 505 or the doors 285, 485 in the closed operational state 300, 500 to be on a selectable time window, see in particular FIGS. 21 to 25, FIGS. 17 to 20, and FIGS. 3 to 12.

Another option is for the alternate embodiment for a timed feed door device 51, that is adapted to be removably engaged to and be in volumetric communication with an interior volume 60 of a gravity-fed vessel 55 that contains a dry granular product 75, the vessel 55 is disposed in an exterior environment 90, the vessel 55 having a flush outlet opening 85, see FIGS. 5 and 6, the alternate embodiment for a timed feed door device 51 further includes the connector 620, in addition to what is included for the timed feed door device 50 aforementioned elements.

The connector 620 is adapted to removably engage the vessel 55 flush outlet opening 85, the connector 620 includes an annular flange 625 that is sized and configured to be greater than the flush outlet opening 85, the annular flange has an internal diameter 630 that is affixed to an annular frustro-conical section 635 that tapers inward to a straight annular section 650, the annular frustro-conical section 635 has a conical inner surface 640 and an opposing conical outer surface 645, the straight annular section 650 has a straight annular section inner surface 655 and an opposing straight annular section outer surface 660. The connector 620 also has a connector interior 665 that is defined by the annular flange internal diameter 630, the conical inner surface 640, and the straight annular section 650 inner surface 655, wherein the annular flange 625 is positioned adjacent to the flush outlet opening 85 with the annular flange 625 being removably engageable to the vessel 55, and the vessel interior volume 60 being in communication 670 with the connector interior 665 therethrough the vessel 55 flush outlet opening 85, see in particular FIGS. 13 to 16, and also FIGS. 5, 6, 11, and 12.
50 Timed feed door device
51 Alternative embodiment of the timed feed door device
52 Animal
53 Surface
55 Vessel that is gravity fed
60 Interior volume of the vessel 55
65 Volumetric communication of the timed feed door device 50 or the alternative
embodiment 51 to the vessel 55
70 Removable engagement of the timed feed door device 50 or the alternative embodiment 51 to the vessel 55
75 Dry granular product, for instance corn, as an example for deer feed
76 Gravity flow of the dry granular product 75
80 Outlet port protrusion of the vessel 55
85 Flush outlet opening of the vessel 55
90 Exterior environment
95 First surrounding sidewall
100 Longitudinal axis
105 First distal end portion of the of the first surrounding sidewall 95
110 First proximal end portion of the first surrounding sidewall 95
115 First inner surface of the first surrounding sidewall 95
120 First outer surface of the first surrounding sidewall 95
125 First interior of the first surrounding sidewall 95
130 Removable engagement adaptation of the first distal end portion 105 to the outlet port 80
135 Communication between the vessel interior volume 60 and the first interior 125
140 Second surrounding sidewall
145 First end portion of the second surrounding sidewall 140
150 Second inner surface of the second surrounding sidewall 140
155 Second outer surface of the second surrounding sidewall 140
160 First cover
165 First aperture of the first cover 160
170 Inner surface of the first cover 160
175 Outer surface of the first cover 160
180 Second cover
185 Inner surface of the second cover 180
190 Outer surface of the second cover 180
195 Second interior of the second surrounding sidewall 140
200 Divider of the second interior 195
205 Primary second interior of the second interior 195
210 Secondary second interior of the second interior 195
215 Affixed nature of the first proximal end portion 110 to the outer surface 175
220 Communication between the first interior 125 and the primary second interior
205 through the first aperture 165
225 Second aperture of the second surrounding sidewall 140
230 Communication into primary second interior 205 through second aperture 225
235 Third surrounding sidewall
240 Longwise axis of the third surrounding sidewall 235
245 Third proximal end portion of the third surrounding sidewall 235
250 Third distal end portion of the third surrounding sidewall 235
255 Third inner surface of the third surrounding sidewall 235
260 Third outer surface of the third surrounding sidewall 235
265 Third interior of the third surrounding sidewall 235
270 Affixed nature of the third proximal end portion 245 to the second outer surface 155
280 Communication of the third interior 265 to the second aperture 225 to the primary second interior 205
285 Door
290 Pivotal attachment of the door 285, 485
295 Pivotal movement of the pivotal attachment 290
300 Closed operational state of the door 285
305 Open operational state of the door 285
310 Means for selectable placing of the door 285 in either the door open operational state 305 or the door closed operational state 300
315 Motor
320 Motor drive pulley
325 Belt
330 Door rotation pulley
335 Door pivot shaft
340 Rotational engagement of the door rotation pulley 330 to the door pivot shaft 335
345 First outer periphery with spaced apart teeth on the motor drive pulley 320
350 Door rotation pulley 330 outer periphery with spaced apart teeth
355 Toothed belt
360 Mateable engagement of the first outer periphery 345, the toothed belt 355, and the door rotation pulley 350
365 Rotational lockstep of the first outer periphery 345 and the door rotation pulley 350
370 Door pivotal rotational resistance about the door pivotal attachment 290, 420 from the dry granular product 75 friction
375 Friction on the door 285 from the dry granular product 75
380 Radially outward protrusion on the motor drive pulley 320
385 Limit switch
390 Activated limit switch 385/595 via momentary contact with protrusion 380/585/590
395 Non-activated limit switch 385/595 without momentary contact of protrusion 380/585/590
400 Rotation of motor drive pulley 320
405 Door 285 moving toward the open operational state 305
410 Door 285 moving toward the closed operational state 300
415 First outer periphery 345 distance about equal to the door rotation pulley 330 outer periphery 350 distance
420 One-quarter rotation of the door 285 pivotal movement 295 in going between the door open state 305 and the door closed state 300
425 Control circuitry to reverse motor rotation each time limit switch 385 is activated in going between the door open state 305 and the door closed state 300
430 Control circuitry to add a selectable time window in going between the door open state 305 and the door closed state 300
435 Third aperture of the second surrounding sidewall 140
440 Fourth surrounding sidewall
445 Lengthwise axis of the fourth surrounding sidewall 440
450 Fourth proximal end portion of the fourth surrounding sidewall 440
455 Fourth distal end portion of the fourth surrounding sidewall 440
460 Fourth outer surface of the fourth surrounding sidewall 440
465 Fourth inner surface of the fourth surrounding sidewall 440
470 Fourth interior of the fourth surrounding sidewall 440
475 Affixed nature of the fourth proximal end portion 450 to the second surrounding sidewall outer surface 155
480 Communication of the fourth interior 470 to the third aperture 435 and the primary second interior 205
485 Ancillary door
490 Pivotal attachment of the ancillary door 485
495 Pivotal movement at pivotal attachment 490
500 Ancillary door 485 closed operational state
505 Ancillary door 485 open operational state
506 Ancillary door 485 rotation pulley
510 Means for selectable placing of the ancillary door 485 in either open operational state 505 or closed operation state 500
515 First double drive pulley
520 Smaller first outer periphery as the toothed belt drive pulley of the first double drive pulley 515
525 Larger second outer periphery as the gear drive of the first double drive pulley
530 First toothed belt
535 Mateable engagement of the first outer periphery 520, the first toothed belt 530, and the door rotation pulley 350
540 Rotational lockstep of the first outer periphery 520 and the door rotation pulley 350
545 Second double drive pulley
550 Smaller fourth outer periphery as the toothed belt drive pulley of the second double drive pulley 545
555 Larger third outer periphery as the gear drive of the second double drive pulley 545
560 Second toothed belt
565 Mateable engagement of the fourth outer periphery 550, the second toothed belt 560, and the ancillary door rotation pulley 506
570 Rotational lockstep of the fourth outer periphery 550 and the ancillary door rotation pulley 506
575 Mated rotation gear drive between the third outer periphery 555 and the second outer periphery 525
580 Friction on the ancillary door 485 from the dry granular product 75
585 First radially outward protrusion disposed on second outer periphery 525
590 Second radially outward protrusion disposed on third outer periphery 555
595 Pair of limit switches
600 Symmetric positioning of the limit switches 595 about the first 515 and second
545 double drive pulleys
605 Non-symmetric rotational clocking of the first 585 and second 590 protrusions to one another via rotational positioning of the second outer periphery 525 gear and the third outer periphery 535
610 Control circuitry of the limit switches 595 to reverse motor 315 rotational direction each time the pair of limit switches 595 are activated to positively confirm a rotational clocking position of the first 515 and second 545 double drive pulleys that positively indicates both the door 285 and said ancillary door 485 open operational state 305/505 or closed operational state 300/500, to operationally initiate the door 285 and the ancillary door 295/485 pivotal movement 490 in the selectable manner 310/510 for placing the door 285 and the ancillary door 485 in either of the door open operational state 305/505 or the door in said closed operational state 300/500.
615 Control circuitry of the limit switches 595 further includes timing circuitry to facilitate the selectable 510 manner for placing the door 285 and the ancillary door 485 in either of the door 285 and the ancillary door 485 open operational state 305/505 or the door 285 and the ancillary door 485 in the closed operational state 300/500 to be on a selectable time window.
620 Connector that is adapted to removably engage the vessel flush outlet opening 85
625 Annular flange of the connector 620
630 Internal diameter of the annular flange 625
635 Frustro conical section
640 Conical inner surface of the frustro conical section 635
645 Conical outer surface of the frustro conical section 635
650 Straight annular section
655 Inner surface of the straight annular section 650
660 Outer surface of the straight annular section 650
665 Connector interior
670 Communication of vessel interior volume 60 to the connector interior 665
675 Ambient light sensor

Accordingly, the present invention of the Timed Feed Door Device has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. A timed feed door device that is adapted to be removably engaged to and be in volumetric communication with an interior volume of a gravity-fed vessel that contains a dry granular product, the vessel is disposed in an exterior environment, the vessel having an outlet port protrusion, said timed feed door device comprising:
a. a first surrounding sidewall that is about a longitudinal axis, said first surrounding sidewall having a first distal end portion and an opposing first proximal end portion with said longitudinal axis spanning therebetween, said first surrounding sidewall further including a first inner surface and an opposing first outer surface, said first surrounding sidewall further including a first interior defined by said first inner surface, said first distal end portion, and said first proximal end portion, said first surrounding sidewall first distal end portion is adapted to removably engage the outlet port protrusion of the vessel such that the vessel interior volume is in communication with said first surrounding sidewall first interior;
b. a second surrounding sidewall that is about said longitudinal axis, said second surrounding sidewall having a first end portion and an opposing second end portion with said longitudinal axis spanning therebetween, said second surrounding sidewall further including a second inner surface and an opposing second outer surface, said first end portion having a first cover with a first aperture disposed therethrough, said first cover having a first cover inner surface and an opposing first cover outer surface, said second end portion having a second cover with a second cover inner surface and an opposing second cover outer surface, said second surrounding sidewall further including a second interior defined by said second inner surface, said first cover inner surface, and said second cover inner surface, said second interior further including a divider that separates said second interior into a primary second interior and a secondary second interior, wherein said first surrounding sidewall first proximal end portion is affixed to said first cover outer surface wherein said first interior and said primary second interior are in communication with one another therethrough said first aperture, said second surrounding sidewall further including a second aperture disposed therethrough from said second inner surface to said second outer surface, wherein said second aperture facilitates communication into said primary second interior;
c. a third surrounding sidewall that is about a longwise axis, said third surrounding sidewall having a third proximal end portion and an opposing third distal end portion with said longwise axis spanning therebetween, said third surrounding sidewall further including a third inner surface and an opposing third outer surface, said third surrounding sidewall further including a third interior defined by said third inner surface, said third distal end portion, and said third proximal end portion, wherein said third surrounding sidewall third proximal end portion is affixed to said second surrounding sidewall outer surface such that said third interior is in communication with said second aperture and therefore said primary second interior;
d. a door that has a pivotal attachment to said third surrounding sidewall third distal end portion on said third inner surface, wherein said pivotal attachment having a pivotal movement about said pivotal attachment, wherein said door in a door closed operational state separates said third interior from the exterior environment, and said door in a door open operational state facilitates communication between said third interior and the exterior environment, said door utilizing said pivotal movement between said closed and open operational states, wherein ultimately with said door in said open state there is communication from the vessel interior to said to said first interior, to said primary second interior, to said third interior, and finally to the exterior environment, thus operationally allowing the dry granular product to gravity flow from the vessel interior volume interior to said first interior, to said primary second interior, to said third interior, and finally to the exterior environment, and when said door is in said closed state there is blocked communication from the vessel interior to said first interior, to said primary second interior, to said third interior to the exterior environment, thus operationally preventing the dry granular product to gravity flow from the vessel interior volume to the exterior environment; and
e. a means for selectable placing of said door in either said door open operational state or said door closed operational state.

2. A timed feed door device according to claim 1, wherein said means for selectable placing of said door in either said door open operational state or said door closed operational state is constructed of a motor rotationally affixed to a motor drive pulley that drives a belt that in turn drives a door rotation pulley that is rotationally engaged to a door pivot shaft that comprises said door pivotal attachment.

3. A timed feed door device according to claim 2, wherein said motor drive pulley, said belt, and said door rotation pulley are constructed of a toothed belt system that comprises said motor drive pulley having a first outer periphery with spaced apart teeth disposed upon and a door rotation pulley outer periphery with spaced apart teeth disposed upon, and a toothed belt with spaced apart teeth disposed upon an internal side of said toothed belt, wherein said motor drive pulley, said belt, and said door rotation pulley are mateably engaged to one another through said toothed belt system to operationally result in said motor drive pulley and said door rotation pulley being in rotational lockstep through said toothed belt to one another to better overcome a door pivotal rotational resistance about said door pivotal attachment due to the friction of the dry granular product as against the door.

4. A timed feed door device according to claim 3, wherein said motor drive pulley further comprises a radially outward protrusion that radially extends outward beyond said motor drive pulley, further included is a limit switch that is disposed upon a portion of said second surrounding sidewall second outer surface and positioned to momentarily contact said radially outward protrusion during a rotation of said motor drive pulley, wherein operationally said limit switch disrupts power to said motor when said radially outward protrusion contacts said limit switch to stop said pivotal movement in either of said door moving toward said open operational state or said door moving toward closed operational state.

5. A timed feed door device according to claim 4, wherein said motor drive pulley first outer periphery has a circumferential distance that is about equal to said door rotation pulley outer periphery circumferential distance to operationally result in about one rotation of said motor drive pulley to about one rotation of said door rotation pully to operationally have said limit switch activate once per rotation of said motor drive pulley while said door rotation pulley moves about one-quarter rotation for said pivotal movement of said door between said open and closed states, said limit switch further including control circuitry to reverse motor rotational direction each time said limit switch is activated to operationally initiate said door pivotal movement in said selectable manner for placing said door in either of said door open operational state or said door in said closed operational state.

6. A timed feed door device according to claim 5, wherein said limit switch control circuitry further includes circuitry that is selected from the group consisting of timing circuitry or ambient light sensing circuitry to facilitate said selectable manner for placing said door in either of said door open operational state or said door in said closed operational state to be on a selectable time window.

7. A timed feed door device according to claim 1, wherein said second surrounding sidewall further comprises a third aperture approximately oppositely positioned from said second aperture about said longitudinal axis, in addition further comprising a fourth surrounding sidewall that is about a lengthwise axis, said fourth surrounding sidewall having a fourth proximal end portion and an opposing fourth distal end portion with said lengthwise axis spanning therebetween, said fourth surrounding sidewall further including a fourth inner surface and an opposing fourth outer surface, said fourth surrounding sidewall further including a fourth interior defined by said fourth inner surface, said fourth distal end portion, and said fourth proximal end portion, wherein said fourth surrounding sidewall fourth proximal end portion is affixed to said second surrounding sidewall outer surface in a position substantially opposing said third surrounding sidewall about said longitudinal axis, such that said fourth interior is in communication with said third aperture and therefore said primary second interior, further comprising an ancillary door that has an ancillary pivotal attachment to said fourth surrounding sidewall fourth distal end portion on said fourth inner surface, wherein said ancillary pivotal attachment having an ancillary pivotal movement about said ancillary pivotal attachment, wherein said ancillary door in an ancillary door closed operational state separates said fourth interior from the exterior environment, and said ancillary door in an ancillary door open operational state facilitates communication between said fourth interior and the exterior environment, said ancillary door utilizing said ancillary pivotal movement between said closed and open operational states, wherein ultimately with said ancillary door in said open state there is communication from the vessel interior to said to said first interior, to said primary second interior, to said fourth interior, and finally to the exterior environment, thus operationally allowing the dry granular product to gravity flow from the vessel interior volume interior to said to said first interior, to said primary second interior, to said fourth interior, and finally to the exterior environment, and when said ancillary door is in said closed state there is blocked communication from the vessel interior to said first interior, to said primary second interior, to said fourth interior to the exterior environment, thus operationally preventing the dry granular product to gravity flow from the vessel interior volume to the exterior environment, further a means for selectable placing of said ancillary door in either said ancillary door open operational state or said ancillary door closed operational state.

8. A timed feed door device according to claim 7 wherein said means for selectable placing of said door and said ancillary door in either said door and said ancillary door open operational states or said door and said ancillary door closed operational states are combined and constructed of a motor rotationally affixed to a first double drive pulley that has larger first gear drive pulley with an adjacent concentrically positioned smaller first toothed belt drive pulley, wherein said first gear drive pulley has a second outer periphery with gear teeth disposed upon and said first toothed belt drive pulley has a first outer periphery with spaced apart toothed belt drive teeth disposed upon and a door rotation pulley outer periphery with spaced apart teeth disposed upon, and a first toothed belt with spaced apart teeth disposed upon an internal side of said first toothed belt, wherein said motor first toothed belt drive pulley, said first belt, and said door rotation pulley are mateably engaged to one another through a first toothed belt system to operationally result in said motor first toothed belt drive pulley and said door rotation pulley being in rotational lockstep through said first toothed belt to one another to better overcome a door pivotal rotational resistance about said door pivotal attachment due to the friction of the of the dry granular product as against the door, further comprising a matching second of said first double drive pulley, wherein said second double drive pulley is rotationally gear drive mated through a third outer periphery with gear teeth disposed upon said third outer periphery to said second outer periphery with said gear teeth such that operationally said motor drives both first and second double drive pulleys, said second double drive pulley includes an adjacent concentrically positioned smaller second toothed belt drive pulley, said second toothed belt drive pulley has a fourth outer periphery with spaced apart toothed belt drive teeth disposed upon and an ancillary door rotation pulley outer periphery with spaced apart teeth disposed upon, and a second toothed belt with spaced apart teeth disposed upon an internal side of said second toothed belt, wherein said second toothed belt drive pulley, said second tooth belt, and said ancillary door rotation pulley are mateably engaged to one another through a second toothed belt system to operationally result in said second toothed belt drive pulley and said ancillary door rotation pulley being in rotational lockstep through said second toothed belt to one another to better overcome an ancillary door pivotal rotational resistance about said ancillary door pivotal attachment due to the friction of the of the dry granular product as against the ancillary door.

9. A timed feed door device according to claim 8, wherein said first and second double drive pulleys each further comprise a respective first and a second radially outward protrusions that radially extend outward beyond said motor drive pulley being respectively disposed upon said second outer periphery and said third outer periphery, further included are a pair of limit switches that are disposed upon a portion of said second surrounding sidewall second outer surface and positioned to have each one of said pair of limit switches be adjacent to each of said second and third outer peripheries and are positioned such that they are symmetric in an opposed relationship about said first and second double drive pulleys to one another, to have each limit switch momentarily contact each of said first and second radially outward protrusions during a rotation of said first and second double drive pulleys, further there is a rotational clocking position as between said second and third outer peripheries respective gears that are meshed such that said first and a second radially outward protrusions are clocked apart in a non-symmetric manner to differentiate at what point in rotational position of said first and second double drive pulleys as each limit switch is activated when said first or second radially outward protrusions rotates into position to contact each of said limit switches at a different point in time, this results in each limit switch being activated independently with a singular unique clock position of each of said first and a second radially outward protrusions means that the pair of limit switches taken together activate with precision on the clocking of either of said first or second radially outward protrusions, said pair of limit switches further including control circuitry to reverse motor rotational direction each time said pair of limit switches are activated to positively confirm a rotational clocking position of said first and second double drive pulleys that positively indicates both said door and said ancillary door open operational state or closed operational state, to operationally initiate said door and said ancillary door pivotal movement in said selectable manner for placing said door and said ancillary door in either of said door open operational state or said door in said closed operational state.

10. A timed feed door device according to claim 9, wherein said pair of limit switches control circuitry further includes circuitry that is selected from the group consisting of timing circuitry or ambient light sensing circuitry to facilitate said selectable manner for placing said door in either of said door open operational state or said door in said closed operational state to be on a selectable time window.

11. An alternate embodiment for a timed feed door device that is adapted to be removably engaged to and be in volumetric communication with an interior volume of a gravity-fed vessel that contains a dry granular product, the vessel is disposed in an exterior environment, the vessel having a flush outlet opening, said timed feed door device comprising:
a. a connector that is adapted to removably engage the vessel flush outlet opening, said connector includes an annular flange that is sized and configured to be greater than the flush outlet opening, said annular flange has an internal diameter that is affixed to an annular frustro conical section that tapers inward to a straight annular section, said annular frustro conical section has a conical inner surface and an opposing conical outer surface, said straight annular section has a straight annular section inner surface and an opposing straight annular section outer surface, said connector has a connector interior that is defined by said annular flange internal diameter, said conical inner surface, and said straight annular section inner surface, wherein said annular flange is positioned adjacent to the flush outlet opening with said annular flange being removably engageable to the vessel, and the vessel interior volume being in communication with said connector interior therethrough the vessel flush outlet opening;
b. a first surrounding sidewall that is about a longitudinal axis, said first surrounding sidewall having a first distal end portion and an opposing first proximal end portion with said longitudinal axis spanning therebetween, said first surrounding sidewall further including a first inner surface and an opposing first outer surface, said first surrounding sidewall further including a first interior defined by said first inner surface, said first distal end portion, and said first proximal end portion, said first surrounding sidewall first distal end portion inner surface is adapted to removably engage said straight annular section outer surface, such that the vessel interior volume is in communication with said connector interior, that in turn is in communication with said first surrounding sidewall first interior;
c. a second surrounding sidewall that is about said longitudinal axis, said second surrounding sidewall having a first end portion and an opposing second end portion with said longitudinal axis spanning therebetween, said second surrounding sidewall further including a second inner surface and an opposing second outer surface, said first end portion having a first cover with a first aperture disposed therethrough, said first cover having a first cover inner surface and an opposing first cover outer surface, said second end portion having a second cover with a second cover inner surface and an opposing second cover outer surface, said second surrounding sidewall further including a second interior defined by said second inner surface, said first cover inner surface, and said second cover inner surface, said second interior further including a divider that separates said second interior into a primary second interior and a secondary second interior, wherein said first surrounding sidewall first proximal end portion is affixed to said first cover outer surface wherein said first interior and said primary second interior are in communication with one another therethrough said first aperture, said second surrounding sidewall further including a second aperture disposed therethrough from said second inner surface to said second outer surface, wherein said second aperture facilitates communication into said primary second interior;
d. a third surrounding sidewall that is about a longwise axis, said third surrounding sidewall having a third proximal end portion and an opposing third distal end portion with said longwise axis spanning therebetween, said third surrounding sidewall further including a third inner surface and an opposing third outer surface, said third surrounding sidewall further including a third interior defined by said third inner surface, said third distal end portion, and said third proximal end portion, wherein said third surrounding sidewall third proximal end portion is affixed to said second surrounding sidewall outer surface such that said third interior is in communication with said second aperture and therefore said primary second interior;
e. a door that has a pivotal attachment to said third surrounding sidewall third distal end portion on said third inner surface, wherein said pivotal attachment having a pivotal movement about said pivotal attachment, wherein said door in a door closed operational state separates said third interior from the exterior environment, and said door in a door open operational state facilitates communication between said third interior and the exterior environment, said door utilizing said pivotal movement between said closed and open operational states, wherein ultimately with said door in said open state there is communication from the vessel interior to said connector interior to said first interior, to said primary second interior, to said third interior, and finally to the exterior environment, thus operationally allowing the dry granular product to gravity flow from the vessel interior volume to said connector interior to said first interior, to said primary second interior, to said third interior and to the exterior environment, and when said door is in said closed state there is blocked communication from said third interior and to the exterior environment, resulting in blocked communication from the vessel interior to said connector interior to said first interior, to said primary second interior, to said third interior and to the exterior environment, thus operationally preventing the dry granular product to gravity flow from the vessel interior volume to the exterior environment; and
f. a means for selectably placing said door in either said door open operational state or said door closed operational state.

12. An alternate embodiment for a timed feed door device according to claim 11, wherein said means for selectable placing of said door in either said door open operational state or said door closed operational state is constructed of a motor rotationally affixed to a motor drive pulley that drives a belt that in turn drives a door rotation pulley that is rotationally engaged to a door pivot shaft that comprises said door pivotal attachment.

13. An alternative embodiment for a timed feed door device according to claim 12, wherein said motor drive pulley, said belt, and said door rotation pulley are constructed of a toothed belt system that comprises said motor drive pulley having a first outer periphery with spaced apart teeth disposed upon and a door rotation pulley outer periphery with spaced apart teeth disposed upon, and a toothed belt with spaced apart teeth disposed upon an internal side of said toothed belt, wherein said motor drive pulley, said belt, and said door rotation pulley are mateably engaged to one another through said toothed belt system to operationally result in said motor drive pulley and said door rotation pulley being in rotational lockstep through said toothed belt to one another to better overcome a door pivotal rotational resistance about said door pivotal attachment due to the friction of the dry granular product as against the door.

14. An alternative embodiment for a timed feed door device according to claim 13, wherein said motor drive pulley further comprises a radially outward protrusion that radially extends outward beyond said motor drive pulley, further included is a limit switch that is disposed upon a portion of said second surrounding sidewall second outer surface and positioned to momentarily contact said radially outward protrusion during a rotation of said motor drive pulley, wherein operationally said limit switch disrupts power to said motor when said radially outward protrusion contacts said limit switch to stop said pivotal movement in either of said door moving toward said open operational state or said door moving toward closed operational state.

15. An alternative embodiment for a timed feed door device according to claim 14, wherein said motor drive pulley first outer periphery has a circumferential distance that is about equal to said door rotation pulley outer periphery circumferential distance to operationally result in about one rotation of said motor drive pulley to about one rotation of said door rotation pully to operationally have said limit switch activate once per rotation of said motor drive pulley while said door rotation pulley moves about one-quarter rotation for said pivotal movement of said door between said open and closed states, said limit switch further including control circuitry to reverse motor rotational direction each time said limit switch is activated to operationally initiate said door pivotal movement in said selectable manner for placing said door in either of said door open operational state or said door in said closed operational state.

16. An alternative embodiment for a timed feed door device according to claim 15, wherein said limit switch control circuitry further includes circuitry that is selected from the group consisting of timing circuitry or ambient light sensing circuitry to facilitate said selectable manner for placing said door in either of said door open operational state or said door in said closed operational state to be on a selectable time window.

17. An alternative embodiment for a timed feed door device according to claim 11, wherein said second surrounding sidewall further comprises a third aperture approximately oppositely positioned from said second aperture about said longitudinal axis, in addition further comprising a fourth surrounding sidewall that is about a lengthwise axis, said fourth surrounding sidewall having a fourth proximal end portion and an opposing fourth distal end portion with said lengthwise axis spanning therebetween, said fourth surrounding sidewall further including a fourth inner surface and an opposing fourth outer surface, said fourth surrounding sidewall further including a fourth interior defined by said fourth inner surface, said fourth distal end portion, and said fourth proximal end portion, wherein said fourth surrounding sidewall fourth proximal end portion is affixed to said second surrounding sidewall outer surface in a position substantially opposing said third surrounding sidewall about said longitudinal axis, such that said fourth interior is in communication with said third aperture and therefore said primary second interior, further comprising an ancillary door that has an ancillary pivotal attachment to said fourth surrounding sidewall fourth distal end portion on said fourth inner surface, wherein said ancillary pivotal attachment having an ancillary pivotal movement about said ancillary pivotal attachment, wherein said ancillary door in an ancillary door closed operational state separates said fourth interior from the exterior environment, and said ancillary door in an ancillary door open operational state facilitates communication between said fourth interior and the exterior environment, said ancillary door utilizing said ancillary pivotal movement between said closed and open operational states, wherein ultimately with said ancillary door in said open state there is communication from the vessel interior to said connector interior, to said to said first interior, to said primary second interior, to said fourth interior, and finally to the exterior environment, thus operationally allowing the dry granular product to gravity flow from the vessel interior volume interior to said connector interior, to said to said first interior, to said primary second interior, to said fourth interior, and finally to the exterior environment, and when said ancillary door is in said closed state there is blocked communication from the vessel interior to said connector interior, to said first interior, to said primary second interior, to said fourth interior to the exterior environment, thus operationally preventing the dry granular product to gravity flow from the vessel interior volume to the exterior environment, further a means for selectable placing of said ancillary door in either said ancillary door open operational state or said ancillary door closed operational state.

18. An alternative embodiment for a timed feed door device according to claim 17 wherein said means for selectable placing of said door and said ancillary door in either said door and said ancillary door open operational states or said door and said ancillary door closed operational states are combined and constructed of a motor rotationally affixed to a first double drive pulley that has larger first gear drive pulley with an adjacent concentrically positioned smaller first toothed belt drive pulley, wherein said first gear drive pulley has a second outer periphery with gear teeth disposed upon and said first toothed belt drive pulley has a first outer periphery with spaced apart toothed belt drive teeth disposed upon and a door rotation pulley outer periphery with spaced apart teeth disposed upon, and a first toothed belt with spaced apart teeth disposed upon an internal side of said first toothed belt, wherein said motor first toothed belt drive pulley, said first belt, and said door rotation pulley are mateably engaged to one another through a first toothed belt system to operationally result in said motor first toothed belt drive pulley and said door rotation pulley being in rotational lockstep through said first toothed belt to one another to better overcome a door pivotal rotational resistance about said door pivotal attachment due to the friction of the of the dry granular product as against the door, further comprising a matching second of said first double drive pulley, wherein said second double drive pulley is rotationally gear drive mated through a third outer periphery with gear teeth disposed upon said third outer periphery to said second outer periphery with said gear teeth such that operationally said motor drives both first and second double drive pulleys, said second double drive pulley includes an adjacent concentrically positioned smaller second toothed belt drive pulley, said second toothed belt drive pulley has a fourth outer periphery with spaced apart toothed belt drive teeth disposed upon and an ancillary door rotation pulley outer periphery with spaced apart teeth disposed upon, and a second toothed belt with spaced apart teeth disposed upon an internal side of said second toothed belt, wherein said second toothed belt drive pulley, said second toothed belt, and said ancillary door rotation pulley are mateably engaged to one another through a second toothed belt system to operationally result in said second toothed belt drive pulley and said ancillary door rotation pulley being in rotational lockstep through said second toothed belt to one another to better overcome an ancillary door pivotal rotational resistance about said ancillary door pivotal attachment due to the friction of the of the dry granular product as against the ancillary door.

19. An alternative embodiment for a timed feed door device according to claim 18, wherein said first and second double drive pulleys each further comprise a respective first and a second radially outward protrusions that radially extend outward beyond said motor drive pulley being respectively disposed upon said second outer periphery and said third outer periphery, further included are a pair of limit switches that are disposed upon a portion of said second surrounding sidewall second outer surface and positioned to have each one of said pair of limit switches be adjacent to each of said second and third outer peripheries and are positioned such that they are symmetric in an opposed relationship about said first and second double drive pulleys to one another, to have each limit switch momentarily contact each of said first and second radially outward protrusions during a rotation of said first and second double drive pulleys, further there is a rotational clocking position as between said second and third outer peripheries respective gears that are meshed such that said first and a second radially outward protrusions are clocked apart in a non-symmetric manner to differentiate at what point in rotational position of said first and second double drive pulleys as each limit switch is activated when said first or second radially outward protrusions rotates into position to contact each of said limit switches at a different point in time, this results in each limit switch being activated independently with a singular unique clock position of each of said first and a second radially outward protrusions means that the pair of limit switches taken together activate with precision on the clocking of either of said first or second radially outward protrusions, said pair of limit switches further including control circuitry to reverse motor rotational direction each time said pair of limit switches are activated to positively confirm a rotational clocking position of said first and second double drive pulleys that positively indicates both said door and said ancillary door open operational state or closed operational state, to operationally initiate said door and said ancillary door pivotal movement in said selectable manner for placing said door and said ancillary door in either of said door open operational state or said door in said closed operational state.

20. An alternative embodiment for a timed feed door device according to claim 19, wherein said pair of limit switches control circuitry further includes circuitry that is selected from the group consisting of timing circuitry or ambient light sensing circuitry to facilitate said selectable manner for placing said door in either of said door open operational state or said door in said closed operational state to be on a selectable time window.
